(19) United States
(12) Patent Application Publication
(10) Pub. No.: US 2014/0059273 A1
(43) Pub. Date: Feb. 27, 2014

(54) HOST APPARATUS AND MEMORY DEVICE

(71) Applicant: KABUSHIKI KAISHA TOSHIBA, Tokyo (JP)

(72) Inventors: Akihisa FUJIMOTO, Yamato-shi (JP); Hiroyuki Sakamoto, Ome-shi (JP); Shinichi Matsukawa, Tokyo (JP); Jun Sato, Kokubunji-shi (JP)

(73) Assignee: Kabushiki Kaisha Toshiba, Tokyo (JP)

(21) Appl. No.: 13/782,268

(22) Filed: Mar. 1, 2013

(30) Foreign Application Priority Data
Aug. 24, 2012 (JP) 2012-185127

(51) Int. Cl. G06F 12/02

(52) U.S. Cl. CPC G06F 12/0246
USPC 711/103

(57) ABSTRACT

According to one embodiment, a host apparatus is capable of accessing memory device. The host apparatus includes application software, a dedicated file system, and an interface circuit. The application software issues, to a file system, a request for access to the memory device. The dedicated file system manages a memory area of the memory device in accordance with a method appropriate to a flash memory in response to the access request. The dedicated file system manages logical address spaces by predetermined unit areas, and sequentially writes data into one of reserved unit areas. The application software issues the access request to the dedicated file system without recognizing a size of the unit area.

### CROSS-REFERENCE TO RELATED APPLICATIONS

This application is based upon and claims the benefit of priority from Japanese Patent Application No. 2012-185127, filed Aug. 24, 2012, the entire contents of which are incorporated herein by reference.

### FIELD

Embodiments described herein relate generally to a host apparatus and a memory device.

### BACKGROUND

Memory devices that use NAND type flash memories are widespread as recording media.

### BRIEF DESCRIPTION OF THE DRAWINGS

FIG. 1 is a block diagram showing hardware configurations of a host apparatus and a memory card according to a first embodiment;

FIG. 2 is a functional block diagram of the host apparatus according to the first embodiment;

FIG. 3 is a block diagram showing a register in the memory card according to the first embodiment;

FIG. 4 is a block diagram of a NAND flash memory according to the first embodiment;

FIG. 5 is a conceptual diagram of a storage area recognized by the host apparatus and a storage area of the memory card according to the first embodiment;

FIG. 6 is a conceptual diagram of the storage areas according to the first embodiment, and shows a method for writing data by the host apparatus;

FIG. 7 is a flowchart showing the data writing method according to the first embodiment;

FIG. 8 is a conceptual diagram of commands according to the first embodiment;

FIG. 9 and FIG. 10 are timing charts showing a command sequence according to the first embodiment;

FIG. 11 is a functional block diagram of a host apparatus according to a second embodiment;

FIG. 12, FIG. 13, and FIG. 14 are conceptual diagrams of memory spaces, FATs, and directory entries according to a third embodiment;

FIG. 15 and FIG. 16 are a flowchart of a data deletion method and a schematic diagram of the data deletion method according to the third embodiment, respectively;

FIG. 17 and FIG. 18 are a flowchart of the data deletion method and a schematic diagram of the data deletion method according to the third embodiment, respectively;

FIG. 19 and FIG. 20 are a flowchart of a data overwriting method and a schematic diagram of the data overwriting method according to the third embodiment, respectively;

FIG. 21 and FIG. 22 are a flowchart of the data overwriting method and a schematic diagram of the data overwriting method according to the third embodiment, respectively;

FIG. 23 is a graph showing a threshold distribution of the NAND flash memory;

FIG. 24 and FIG. 25 are flowcharts showing of the operations a memory card and a host apparatus according to a fourth embodiment, respectively;

FIG. 26 and FIG. 27 are a flowchart of a data writing method and a schematic diagram of the data writing method according to a sixth embodiment, respectively;

FIG. 28 is a flowchart showing the data writing method according to the sixth embodiment;

FIG. 29 is a flowchart showing a data writing method according to a seventh embodiment;

FIG. 30 is a block diagram of a memory cell array;

FIG. 31 is a conceptual diagram showing the correspondence between logical address spaces and blocks according to the first to seventh embodiments; and

FIG. 32 is a conceptual diagram of garbage collection.

### DETAILED DESCRIPTION

In general, according to one embodiment, a host apparatus is capable of accessing a memory device. The host apparatus includes: application software; a dedicated file system; and an interface circuit. The application software issues, to a file system, a request for access to the memory device by an application interface (API). The dedicated file system manages a memory area of the memory device in accordance with a method appropriate to a flash memory in response to the access request. The interface circuit enables communication between the dedicated file system and the memory device. The dedicated file system manages logical address spaces of the memory device by predetermined unit areas, and sequentially writes data into one of reserved unit areas. The sequential writing into the unit areas is executed by one or more write commands. The application software issues the access request to the dedicated file system without recognizing a size of the unit area.

### 1. First Embodiment

A host apparatus according to a first embodiment is described. A memory system including a memory card and the host apparatus which accesses the memory card is described below by way of example. In the example described herein, the memory card is an SD memory card.

### 1.1 Regarding the Configuration

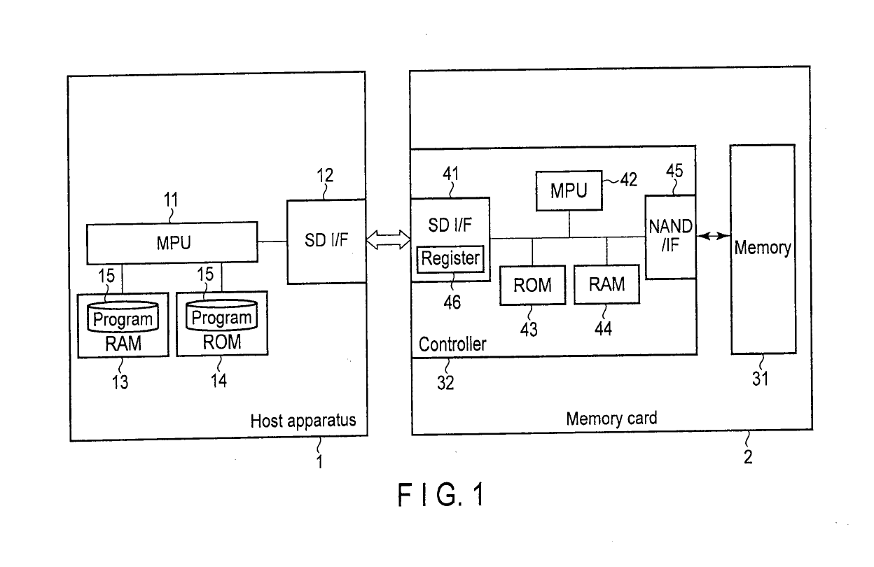

Initially, the configurations of the host apparatus and the memory card are described with reference to FIG. 1. FIG. 1 is a block diagram showing the hardware configuration of the memory system according to the present embodiment.

### 1.1.1 Regarding the Configuration of the Host Apparatus

The configuration of the host apparatus is first described with reference to FIG. 1. As shown, a host apparatus 1 includes a micro processing unit (MPU) 11, an SD interface circuit 12, a read only memory (ROM) 14, and a random access memory (RAM) 13.

The MPU 11 controls the whole operations of the host apparatus 1. When the host apparatus 1 is powered-on, firmware (control program (instruction)) stored in the ROM 14 is read onto the RAM 13. The MPU 11 executes predetermined processing in accordance with the firmware (instruction). The MPU 11 executes a program 15 held in the RAM 13 and the ROM 14 to enable various functions. This program 15 includes, for example, various application software, an operating system, and a file system.

The SD interface circuit 12 controls a communication protocol between the host apparatus 1 and a memory card 2. The SD interface circuit 12 operates in accordance with various arrangements required for the commutation between the host apparatus 1 and the memory card 2, and includes various sets of commands which can be recognized mutually with a later-described SD interface 41 of the memory card 2.

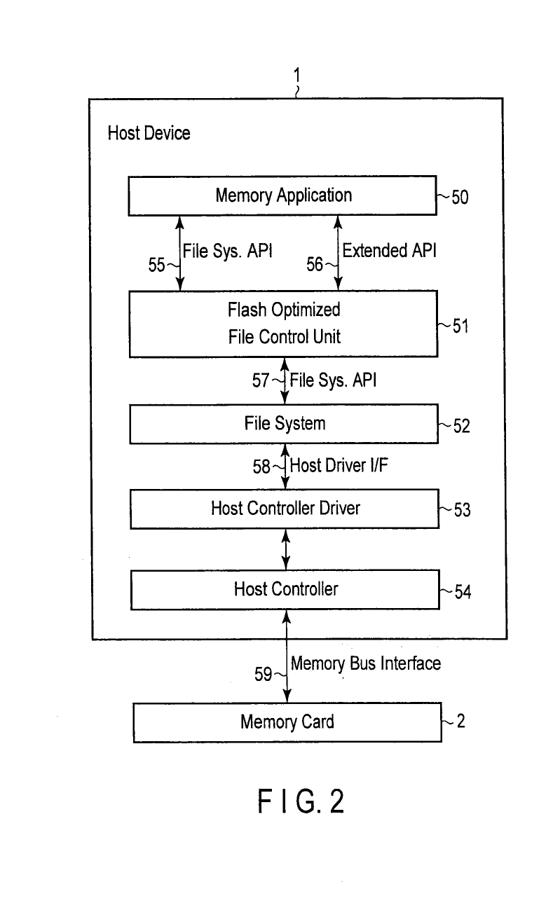

FIG. 2 is a functional block diagram showing functions of the host apparatus 1 enabled by the MPU 11 and the SD interface circuit 12. At least some of these functions are enabled by, for example, the execution of the program 15 in the RAM 13 and the ROM 14. As shown, the host apparatus 1 includes an application 50, a file control unit 51, a file system 52, a host controller driver 53, a host controller 54, basic application program interfaces (API) 55 and 57, an extended API 56, a host driver interface 58, and a memory bus interface 59.

The application 50 is application software executed by the MPU 11. The application 50 issues file open/close, data writing, reading, erasing instructions to the file control unit 51, and thereby accesses the memory card 2.

The file control unit 51 and the file system 52 function together as a dedicated file system. The file system 52 is a file system body of the dedicated file system, and is, for example, a file allocation table (FAT) file system. The file system 52 is a scheme for managing file data recorded in a recording medium (memory card 2) to be managed. The file system 52 records management information (FAT) in the memory card 2, and uses this management information to manage the file data. The file control unit 51 manages a memory space of the memory card 2 by an allocation unit (AU) indicating a physical boundary of the memory in accordance with the file system 52, and controls the memory card 2 in accordance with its Speed Class. The AU and the Speed Class will be described later.

The basic API 55 is a standard file system API, and is used between the application 50 and the file control unit 51 and between the file control unit 51 and the file system 52. The extended API 56 is an API which is the extension of the function of the basic API 55. The extended API 56 is prepared for the control of the memory card 2 by the file control unit 51, and is used between the file control unit 51 and the file system 52. Details of the basic API 55 and the extended API 56 are described in a fifth embodiment.

The host controller driver 53 is connected to the file system 52 by the host driver interface 58. The host controller driver 53 controls the host controller 54 in accordance with a command from the dedicated file system.

The host controller 54 refers to the SD interface circuit 12 in FIG. 1, and is obtained by a semiconductor circuit. The host controller 54 controls the memory card 2 in accordance with a program of the host controller driver 53. The host controller 54 and the memory card 2 are connected by the memory bus interface 59. The host controller 54 uses a command defined by the SD interface to issue a command to the memory card 2.

### 1.1.2 Regarding the Configuration of the Memory Card

Now, returning to FIG. 1, the configuration of the memory card 2 is described. As shown, the memory card 2 includes a NAND flash memory 31 and a controller 32.

The NAND flash memory 31 stores data in a nonvolatile manner. The NAND flash memory 31 writes and reads data by a unit called a page which is a set of a plurality of memory cells. A unique physical address is allocated to each page. Further, the NAND flash memory 31 erases data by a unit Called a block which is a set of a plurality of pages. The physical addresses may be allocated by the block unit.

The controller 32 instructs the NAND flash memory 31 to write, read, and erase data in response to the request from the host apparatus 1. The controller 32 manages the storage state of the NAND flash memory 31. The management of the storage state includes the management of which page (or block) of the physical address holds data of which logical address, and the management of which page (or block) of the physical address is erased (having nothing written therein or holding invalid data).

As shown in FIG. 1, the controller 32 includes the SD interface 41, an MPU 42, a RAM 44, a ROM 43, and a NAND interface 45.

The SD interface 41 controls communication between the memory card 2 and the host apparatus 1. More specifically, the SD interface 41 controls the transfer of various commands and data to/from the SD interface circuit 12 of the host apparatus 1. The SD interface 41 includes a register 46. The register 46 will be described later.

The MPU 42 controls the whole operation of the memory card 2. When the memory card 2 is supplied with electric power, firmware (control program (instruction)) stored in the ROM 43 is read onto the RAM 44. The MPU 42 executes predetermined processing in accordance with the firmware (instruction). The MPU 42 creates various tables (described later) on the RAM 44 in accordance with the control program, or executes predetermined processing for the NAND flash memory 31 in accordance with the command received from the host apparatus 1.

The ROM 43 is used to store the control program to be executed by the MPU 42. The RAM 44 is used as a working area of the MPU 42, and is used to temporarily store the control program and various tables. Such tables include a translation table (logical address/physical address translation table) which holds information of a relationship between logical addresses allocated to data by the file system 52 and physical addresses of the pages in which the data are stored. The NAND interface 45 performs interface processing between the controller 32 and the NAND flash memory 31.

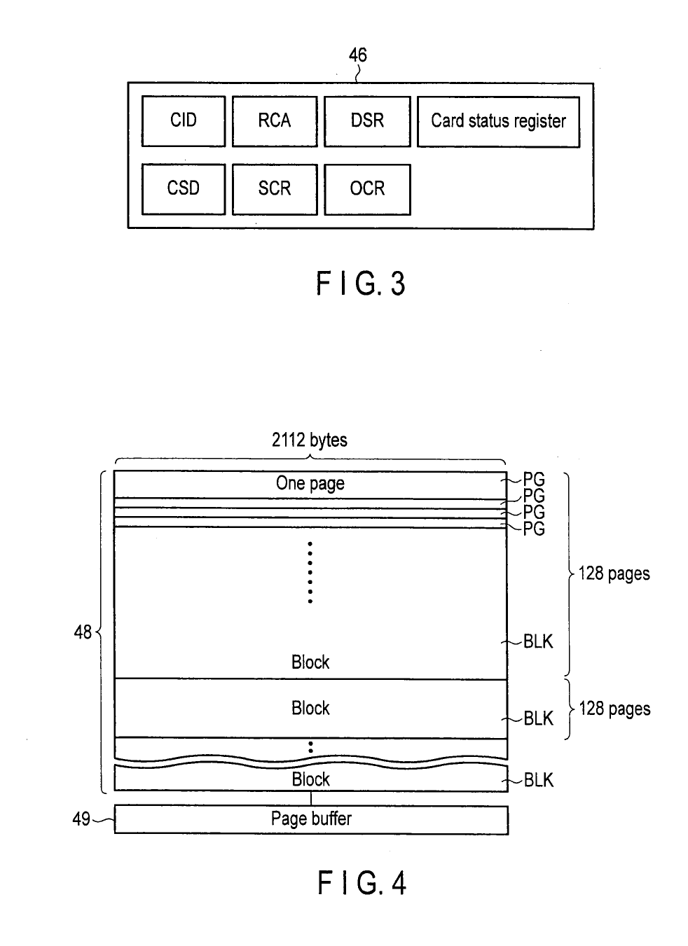

FIG. 3 is a block diagram of the register 46 in the SD interface. As shown, the register 46 has various registers including a card status register, a CID, an RCA, a DSR, a CSD, an SCR, and an OCR. These registers are used to store, for example, error information, an individual number of the memory card 2, a relative card address, a bus driving capability of the memory card 2, a characteristic parameter value of the memory card 2, data arrangement, and operating voltages when the operating range voltage of the memory card 2 is limited.

The register 46 (e.g. CSD) is used to store, for example, the Speed Class of the memory card 2, the time required to copy data, and an AU size. The Speed Class is defined by the minimum writing speed ensured by the memory card 2. The maximum writing speed is set by the Speed Class. Therefore, the host apparatus 1 reads such information from the register 46 and can thereby know the Speed Class and the AU size of the memory card 2. It should be noted that details of the Speed Class are described as a “performance class” in U.S. Pat. No. 7,953,950 incorporated herein by reference.

### 1.2 Regarding the Memory Space of the Memory System

Now, the memory space of the memory system having the above-mentioned configuration is described. FIG. 4 is a conceptual diagram of the memory area of the NAND flash memory 31.

As shown, the NAND flash memory 31 includes a memory cell array 48 and a page buffer 49. The memory cell array 48 includes a plurality of blocks BLK. Each of the blocks BLK includes a plurality of pages PG, and each of the pages PG includes a plurality of memory cell transistors. The size of each page PG is, for example, 2112 bytes, and each block BLK includes, for example, 128 pages. Data is erased by the block BLK unit. The page buffer 49 temporarily holds data to the NAND flash memory 31 and data from the NAND flash memory 31. The numerical values shown here are illustrative only, and the numerical values vary depending on the kind of NAND flash memory.

The memory space includes, for example, a system data area, secret data area, protected data area, and a user data area, depending on the kind of data to be saved. The system data area holds data necessary for the operation of the controller 32. The secret data area holds key information used for encryption and secret data used for authentication, and cannot be accessed by the host apparatus 1. The protected data area holds important data and secure data. The user data area can be freely accessed and used by the host apparatus 1, and holds user data such as AV content files and image data.

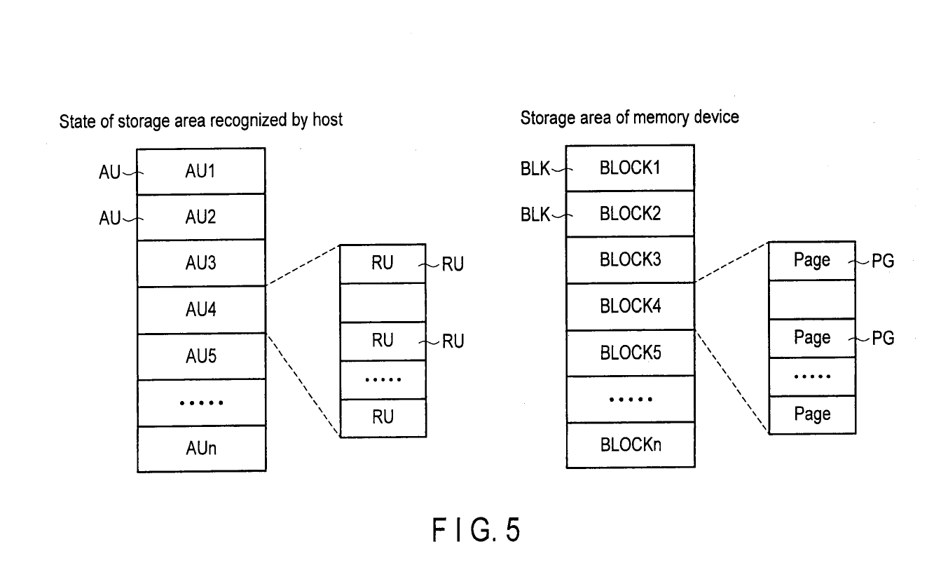

FIG. 5 is a conceptual diagram showing the memory space viewed from the host apparatus 1, and the physical structure of the memory area of the memory card 2. As described above, the memory area of the memory card 2 includes a plurality of physical blocks BLK, and each of the blocks BLK includes a plurality of pages.

When the Speed Class is used, the host apparatus 1 manages the memory space by two units: an allocation unit AU and a recording unit (RU). The RU corresponds to a minimum unit to write data by one multi-block write command issued by the host apparatus 1. That is, the host apparatus 1 can write data by one or more RU units. The controller 32 then writes the write-data into a proper page. The size of the RU is larger than, for example, a page size, and is the integral multiple of the page size. Thus, the memory card 2 writes the write data of the RU size into a plurality of pages of sequential physical addresses.

The AU is a set of a predetermined number of sequential RUs. The host apparatus 1 manages the memory space of the memory card 2 by the AU. When writing data, the host apparatus 1 reserves areas by the AU unit, and also calculates a free space of the memory card 2 by the AU unit. This operation is described below in detail. The AU is a physical boundary in the user data area, and, for example, has a size which is the integral multiple of the size of the block BLK. The logical address indicating the AU and the physical address indicating the physical block are translated by the table, and therefore have any correlation and are not limited in correlation.

Thus, the RU means a plurality of sequential pages, and the AU means a plurality of sequential blocks. In the host apparatus 1, the size of the AU is recognized by the dedicated file system, and is not recognized by the application 50. That is, the application 50 issues a data write request to the dedicated file system regardless of the AU, and the dedicated file system which manages the memory space by the AU properly controls the memory card 2 in accordance with the write request.

### 1.3 Regarding a Data Writing Method

Now, a method of writing data into the memory card 2 by the host apparatus 1 is described. The memory space viewed from the host apparatus 1 is further formatted by the file system, and is managed by a cluster unit which is a management unit of the file system. The size of the cluster varies by the kind of file system and by the capacity of the memory card. The size of the RU is, for example, larger than a cluster size, and is the integral multiple of the cluster size.

### 1.3.1 Regarding the Concept of the Writing Method

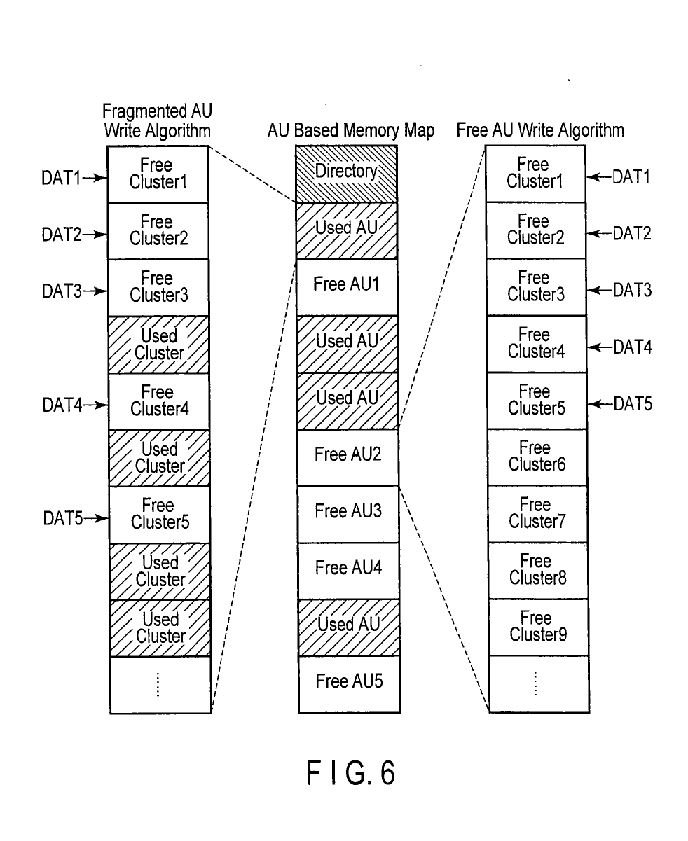

First, the general concept of the writing method according to the present embodiment is described with reference to FIG. 6. FIG. 6 is a conceptual diagram showing an AU-based memory map and showing the used AUs and free AUs. As shown, each AU is a set of clusters. FIG. 6 shows the difference of writing methods of two kinds of algorithms when, for example, data DAT1 to DAT5 are respectively written into five clusters.

The example in the right part of FIG. 6 shows an algorithm employed by the dedicated file system according to the present embodiment. When writing data, the host apparatus 1 according to the present embodiment selects one free AU as shown by a “Free AU Write Algorithm” in FIG. 6. The host apparatus 1 preferentially selects a free AU in which all clusters are unused, but may select an AU in which data is sequentially written into part of the clusters. Then the host apparatus 1 writes data into the selected AU. Thus, the data DAT1 to DAT5 are inevitably sequentially written starting from the head address in the AU (hereinafter called “sequential writing”).

In contrast, the example in the left part of FIG. 6 shows an algorithm employed by a conventional file system. A “Fragmented AU Write Algorithm” in FIG. 6 is a method that selects not only free AUs but also AUs (fragmentation areas) in which data are already written in some clusters but the remaining clusters are unused. In the case shown in FIG. 6, the data DAT1 to DAT5 are written into the fragmentation areas. According to the present method, the AUs can be effectively used. However, it is necessary not only to write the data DAT1 to DAT5 but also to copy the written data. Therefore, this cannot be said to be an optimal method of writing into the NAND flash memory. The reason is that data cannot be overwritten in the NAND flash memory. As long as there are free AUs, the host apparatus 1 writes data in accordance with the free AU write algorithm without using the fragmented AU write algorithm.

The host apparatus 1 may use an AU in which data is already sequentially written into part of clusters and the remaining clusters are unused. In this method, the usage efficiency of the memory device is improved.

### 1.3.2 Regarding Details of the Writing Method

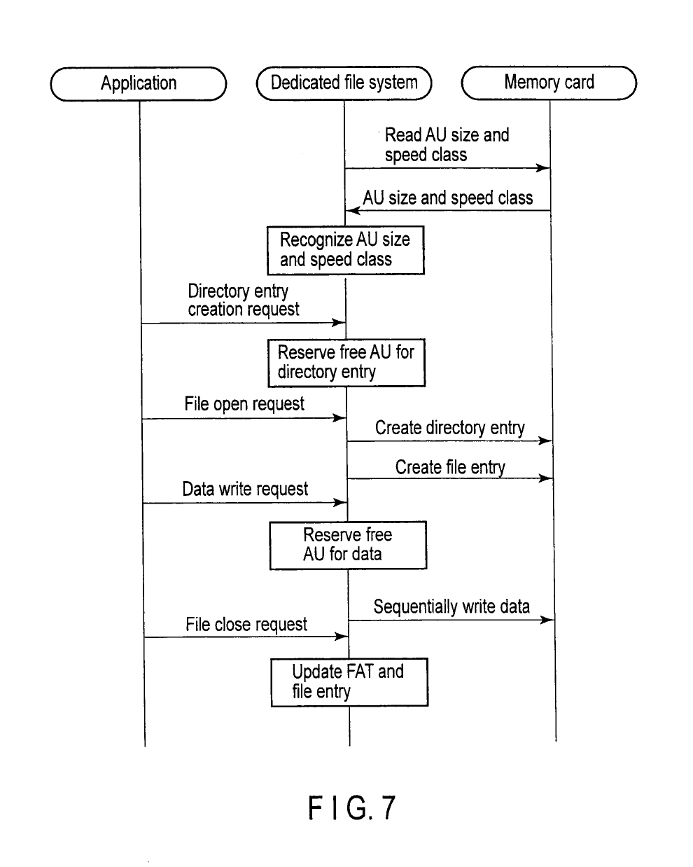

Now, details of the writing method according to the present embodiment are described with reference to FIG. 7. FIG. 7 is a flowchart showing the operations of the application 50, the dedicated file system, and the memory card 2 during data writing.

As shown, the dedicated file system reads the AU size and Speed Class information from the memory card 2 by any timing. The AU size and Speed Class information can be read from the register 46 of the memory card 2, as described above. In this way, the dedicated file system recognizes the AU size and the Speed Class of the memory card 2.

In response to a directory creation request from the application 50, the dedicated file system reserves a free AU for creating a directory entry (e.g. AU1 in FIG. 6). The dedicated file system uses this AU for the creation of the directory entry. When a plurality of directories are created later, the directory entries of the respective directories are allocated to the same AU. In this way, the memory card 2 can efficiently process random accesses to the directory entries in the AU. When the AU has no more free space, the dedicated file system reserves another AU for the directory entry.

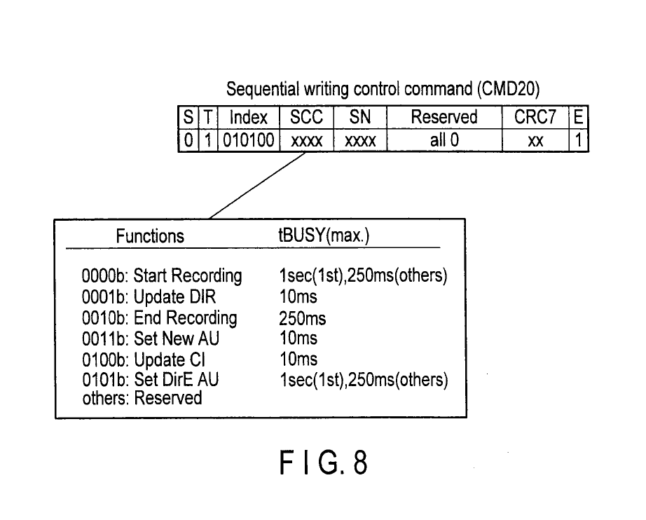

In response to a file open request from the application 50, the dedicated file system creates a directory entry in the reserved AU for the directory entry creation. Update area of directory entry may be specified by CMD20 Update DIR command. The dedicated file system may be used anther method. That is, the dedicated file system may use a “CMD20 Set DirE AU” command to specify the AU in which a directory entry is created or updated. The CMD 20 Set DirE AU command will be described later with reference to FIG. 8 and is defined by an SD interface specification. In this method, the dedicated file system then write file entry data into a directory entry area in the specified AU without “CMD20 Update DIR” command. As a result, the memory card 2 can efficiently manage the writing of the file entry. In the following examples even CMD20 Update DIR is used, the CMD20 Update DIR command can be omitted if the directory entry is created in the AU specified by CMD20 Set DirE AU command.

The application 50 then issues a data write request to the dedicated file system. The write data is stored on the RAM 13 in FIG. 1. In this case, the application 50 notifies the dedicated file system of the location of the data on the RAM 13 and its size. As described above, the application 50 does not need to recognize the AU size and the Speed Class information. The MPU 11 generally has a page management function, and can therefore arrange the pages to be capable of sequential reading. The dedicated file system reserves a free AU for data writing, and sequentially writes data into this AU.

At the completion of the data writing, the application 50 issues a file close request. The dedicated file system updates a FAT table and the file entry to determine recorded data.

### 1.3.3 Regarding the CMD20 and a Command Sequence

Now, the CMD20 and a command sequence for data writing are described. FIG. 8 is a conceptual diagram showing the configuration of the CMD20.

As shown, the CMD20 includes at least an index field, an operation specifying field SCC, a stream number field SN, and a cyclic redundancy check (CRC) field. “S” before the index field indicates a start bit, and is always “0”. “T” is a transmitter bit, “1” indicates a command from the host apparatus, and “0” indicates a response from the memory card.

The index field has “14h” bit sequence (6-bit) in which decimal “20” is represented in a hexadecimal form in order to specify that the command is the CMD20. The operation specifying field SCC has a bit sequence that specifies the kind of operation required by the CMD20. Depending on the argument within the operation specifying field SCC, the CMD20 behaves as a command to start writing (recording) (“Start Recording” in FIG. 8), to designate a directory entry (DIR) creation AU (“Set DirE AU” in FIG. 8), to update the DIR (the creation of a file entry, “Update DIR” in FIG. 8), to write in a new AU (“Set New AU” in FIG. 8), to finish writing (recording) (“End Recording” in FIG. 8), or to update the CI (“Update CI” in FIG. 8). The stream number field SN includes an argument that specifies which of streams 1 to 4 the instruction by the CMD20 corresponds to. The meaning of each instruction will be described later. The CRC field has a CRC code. In the case of a single stream standard, the new AU writing in SCC, the writing (recording) end, and the stream number field SN are not supported. When the stream number field SN is “0000b”, a single stream operation is executed.

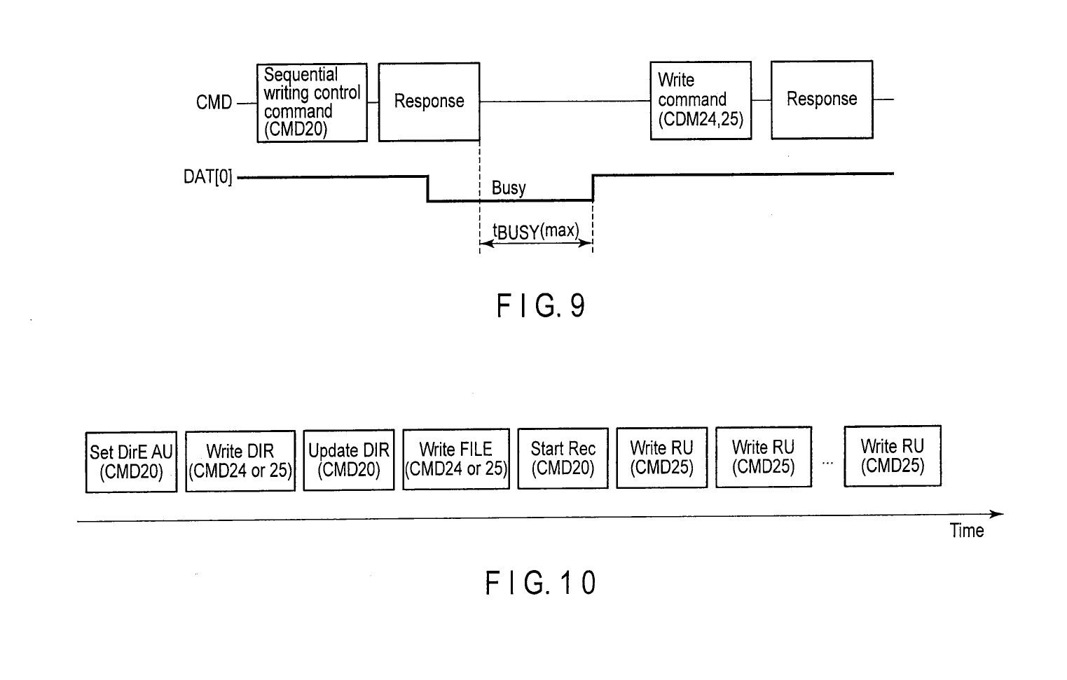

FIG. 9 illustrates the CMD20 and signals later transferred between the memory card 2 and the host apparatus 1. As shown, at least a command line (CMD) and a data line (DAT[0]) are defined in the SD interfaces 12 and 41. If the host apparatus 1 sends the CMD20 on the command line, the memory card 2 sends a response on the command line. When this CMD20 is received by a memory card which does not recognize the CMD20, this memory card does not send any response. The memory card 2 sends a response, and also sends a busy signal to the host apparatus 1 on the data line. A time tbusy(max) that elapses before a busy state is judged to have timed out is predetermined in accordance with the function of the CMD20 (see FIG. 8).

After the release of the busy state, the host apparatus 1 sends a write command (CMD24 or CMD25) to the memory card 2 on the command line. Thus, the host apparatus 1 issues the write command after issuing the CMD20 in principle. As a result, the processing specified by an SCC field of the CMD20 is performed for a memory address specified by the argument of the subsequent write command. For example, it is recognized by the “DIR update” command that the subsequent write command indicates the writing of a file entry. The memory card 2 sends a response to the write command to the host apparatus 1 on the command line. When receiving a normal response, the host apparatus 1 then uses the data line to send write data to the memory card 2.

Now, a specific example of how data is written into the memory card 2 by the host apparatus 1 is described with reference to FIG. 10. FIG. 10 is a time chart showing, in a time-series form, commands issued to the memory card 2 from the host apparatus 1.

As described above, the dedicated file system selects an erased AU at the start of Speed Class writing, and then sequentially writes data into this AU.

In the following explanation, the function of the CMD20 specified by the field SCC is cited as a command name of this function. That is, the CMD20s for the Start Recording, the Set DirE AU, the Update DIR, the Set New AU, the End Recording, and the Update CI are respectively referred to as a write start command, a DIR creation AU designation command, a DIR update command, a new AU write command, a writing end command, and a CI update command.

When the host apparatus 1 receives a directory creation request from the application 50, the dedicated file system issues a DIR creation AU designation command (“Set DirE AU”), and reserves an AU for creating a directory entry (e.g. AU1 in FIG. 6). The place of the AU is designated by the next memory access command (“Write DIR”). When an AU for DIR creation has already been reserved by the use of this command, it is not necessary to again issue this command. This DIR creation AU designation command has a field SSC of “0101b”. In response to this DIR creation AU designation command (“Set DirE AU”), the memory card 2 initializes the designated AU (sets all data to “0”). Details of this function will be described later. The dedicated file system then issues a single block write command (CMD24 or CMD25) to write a file entry that indicates a parent directory (“. .”) and a current directory (“.”) (“Write DIR”). When a directory entry has already been created, the DIR creation AU designation command and the Write DIR are omitted.

Next, when receiving a file open request from the application 50, the dedicated file system then sends the DIR update command (“Update DIR”) to the memory card 2. The dedicated file system then issues a write command (CMD24 or CMD25) to update a specific 512-byte area in the directory entry, and sends write data (“Write FILE”) for the file entry. The write data includes the file name, attributes, and date of the file to be created. The memory card 2 assumes that the 512-byte directory entry indicated by the memory address of the present command is updated more than one time. This completes the processing for the file open request.

The dedicated file system then receives a data write request from the application 50. Data is stored in the RAM 13, and the location and size of the data is notified to the dedicated file system. The dedicated file system then reserves, for example, a free AU for data writing (e.g. AU2 in FIG. 6) to write stream data, and transmits a write start command (“Start Rec”) to the memory card 2. The write start command is a CMD20 having a field SSC of “0000b”. The dedicated file system continuously issues a write command (“Write AU”). This write command is a CMD25. As this command CMD25 is located immediately after the write start command, the memory card 2 recognizes that this command is a data write command for writing actual data (stream data). The argument of this write command CMD25 includes the head logical address of the reserved AU2. The stream data is transmitted to the memory card 2 from the host apparatus 1 after the write command. This stream data is then sequentially written into the AU2. That is, the memory card 2 sequentially writes the received data by the RU unit from the lowermost address of the free AU2 to higher addresses. When the AU2 has become full, the memory card 2 acquires a next free space (e.g. AU3) and continues writing. The logical address/physical address translation table of the AU written to the end are updated.

In the single stream recording, if data is sequentially transmitted to the memory card and the writing of the data is continued without interruption, the write start command (“Start Rec”) may be only issued at the beginning of a series of write data (write commands are repeatedly issued in the example shown in FIG. 10).

When all the data has been written in the memory card 2, the processing of the data write request from the application 50 is completed.

The dedicated file system then receives a file close request from the application 50. In response to this request, the dedicated file system creates a data chain of the FATs corresponding to the written data, and updates the area from the unused area to a used area. The dedicated file system also updates the data size and update time of the file entry. This completes the processing for the file close request.

When a different file is written into the same directory, a new file entry can be created in an area specified by the “Update DIR”. If the AU reserved for data writing is still free, the different file data can be additionally written after the previous file data. In this case, the “Start Rec” command is not issued. The data AU is characterized by being capable of continuing sequential writing and generating no useless areas even when a plurality of files are created as described above. When the area specified by the “Update DIR” is no longer free, an “Update DIR” is again issued for a next 512-byte area, and a new file entry is created. However, when a DIR creation AU has been specified, a directory entry can be created anywhere in the AU in this area without the use of the “Update DIR” command.

### 1.4 Regarding a Method of Calculating a Free Space of the Memory Card 2

Now, a method of calculating a free space of a sequentially writable area of the memory card 2 by the host apparatus 1 according to the present embodiment is described.

As described above, the host apparatus 1 according to the present embodiment manages the memory card 2 by the AU unit. Therefore, it is difficult to calculate a free space of a sequentially writable area from the FAT or bitmap information, and it may be difficult for the application 50 to acquire free space information of the memory card 2 by the basic API 55. Thus, the application 50 uses the extended API 56 to acquire free space information of the memory card 2.

The dedicated file system then searches for unused AUs, and calculates a free space of a sequentially writable area by the number of the unused AUs, and notifies the application 50 of the calculation results. More specifically, AUs in which the FATs are marked by free clusters all over are determined to be “free AUs” (AUs including clusters holding effective data, clusters with defective cluster marks, and clusters with final cluster marks are excluded). The number of free AUs in the whole memory card 2 is then calculated, and the sum is determined to be the remaining space of the memory card 2. AUs in which data writing is effective (AUs in which the sequential writing is effective) and which still have free space may be added to the free space. By referring to the FAT, it is possible to know whether the cluster is holding effective data, whether there is a defective cluster mark, and whether there is a final cluster mark.

For example, in FIG. 6, the used AU is an AU in which at least one of the clusters is in use (“Used Cluster”). Therefore, an AU having at least one used cluster is a used AU even if this AU includes an unused cluster, and this AU is excluded from the free space calculation. In this regard, an AU in which data is sequentially written into part of clusters and the remaining clusters are unused may contribute to the free space calculation, because data can be sequentially written into the remaining clusters. That is, when there is a sequentially writable region in a used AU, the dedicated file system considers that region as a free area. Therefore, in FIG. 6, the free space of a sequentially writable area of the memory card 2 is calculated on the basis of four free AUs: AU1, AU3 to AU5 (the AU5 is assumed as the final AU).

### 1.5 Advantageous Effects According to the Present Embodiment

As described above, the host apparatus according to the present embodiment can reduce the load of application development and improve the speed of writing into the NAND flash memory. These advantageous effects are described below.

In an SD memory card, an SD Speed Class is specified according to its writing speed. Thus, in order to maximize the function of the memory card, it is preferable that the host apparatus performs write processing that conforms to the Speed Class of each memory card. However, to this end, the host apparatus needs to be designed in conformity to the Speed Class. There are a large number of requirements for this purpose, and an optimum design is difficult. This inhibits the spread of the Speed Class.

The host apparatus manages the memory card by the file system. However, newly recognizing an AU size and managing memory areas impose a heavy load on the host apparatus. Moreover, performance deteriorates but there is no problem in compatibility without the management of the AU size. This inhibits the spread of the host apparatus that takes the AU size into account. However, with such a design, it is difficult to ensure the minimum performance of the SD memory card defined by the Speed Class.

Another problem is that even in the case of a host apparatus that takes the AU size into account, the host apparatus only recognizes up to the maximum value of the defined AU size. It is therefore difficult to maintain the compatibility with the current host apparatus when a larger AU size is needed.

Furthermore, a conventional file system employs an algorithm that also actively uses fragmented areas for the effective use of the memory areas. However, in this algorithm, data is not necessarily written sequentially, and copying of data is needed. Thus, the data writing speed deteriorates.

In this respect, the host apparatus 1 according to the present embodiment includes the file control unit 51, and the file control unit 51 and the file system 52 function as the dedicated file system. The dedicated file system recognizes an AU size and a Speed Class, and controls the memory card 2 in accordance with such information. Therefore, the application 50 does not need to recognize the AU size and the Speed Class. That is, the application 50 does not need to manage the memory area in the AU size and control writing in accordance with the Speed Class. Consequently, the load of the development of the application 50 can be reduced.

Furthermore, the dedicated file system searches for a free space of a sequentially writable area by the AU unit for data writing. That is, fragmented areas are not used. The dedicated file system then always sequentially writes into the free AU. Thus, the data copying operation is not needed, and the performance of the memory card 2 can be maximized. The memory card used in accordance with this scheme can be used in the host device of the conventional file system, and is therefore characterized by being capable of maintaining compatibility.

The directory entry is created for each directory, and is characterized by being repeatedly updated by a small area (e.g. 512-byte) unit. Therefore, the dedicated file system reserves an AU for the directory entry, and creates a plurality of directory entries on one AU, so that the memory card is characterized in that writing into the small area can be easily managed.

### 2. Second Embodiment

Now, a host apparatus according to a second embodiment is described. According to the present embodiment, the extended API 56 in the first embodiment is eliminated. The differences between the first embodiment and the present embodiment are only described below.

### 2.1 Regarding the Configuration of the Host Apparatus 1

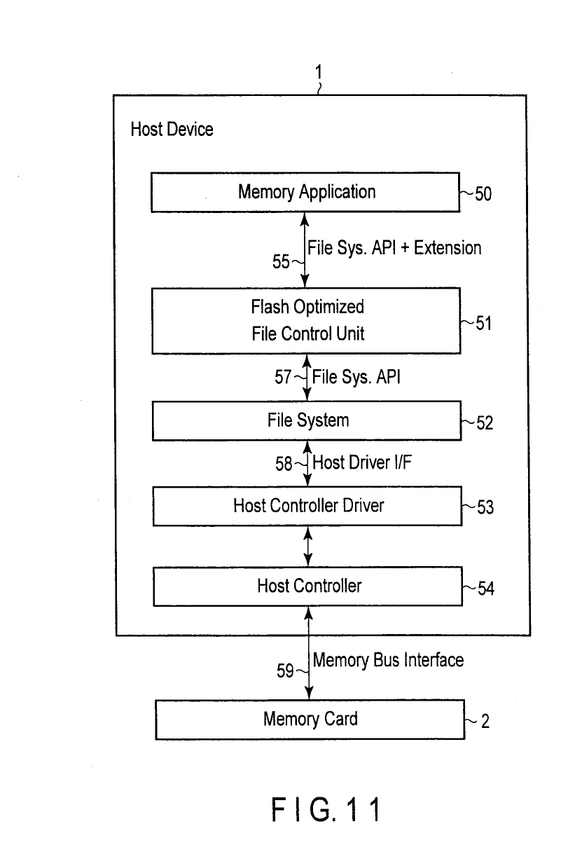

FIG. 11 is a functional block diagram of the host apparatus 1 according to the present embodiment. As shown, the host apparatus 1 according to the present embodiment is obtained by modifying FIG. 2 described in the first embodiment in the following manner:

(a) The extended API 56 is eliminated.

(b) The argument and returned value of the basic API 55 are extended.

That is, according to the present embodiment, the argument and the returned value are extended on the basis of the conventional basic API to enable the function similar to that of the extended API.

For example, one normal function in the API is a file open function. In this function, information regarding whether to align with an AU boundary during the writing of a file is added as a flag to the argument of the file open function. If the flag is “0”, the dedicated file system operates as heretofore. That is, a free area is not reserved by the AU unit, and fragmented areas are also used to write a file. On the other hand, if the flag is “1”, the dedicated file system uses the AU boundary as a unit as has been described in the first embodiment to sequentially write data.

When the above-mentioned flag is not provided, the dedicated file system can apply a method that uses the AU boundary as a unit as has been described in the first embodiment for all memory writing to sequentially write data. In this case, fragmented AUs are not used, so that the efficiency of memory use deteriorates, but the performance is improved.

### 2.2 Advantageous Effects According to the Present Embodiment

The configuration according to the present embodiment permits one API to be compatible with already developed conventional applications, and also permits the use of extended functions. Thus, the functions described in the first embodiment are enabled by a simpler configuration.

### 3. Third Embodiment

Now, a host apparatus according to a third embodiment is described. In the present embodiment, details of the data deletion and overwriting operations according to the first and second embodiments are described. The differences between the first and second embodiments and the present embodiment are only described below.

### 3.1 Regarding a FAT File System

First, the FAT file system is briefly described before the detailed description of the operation.

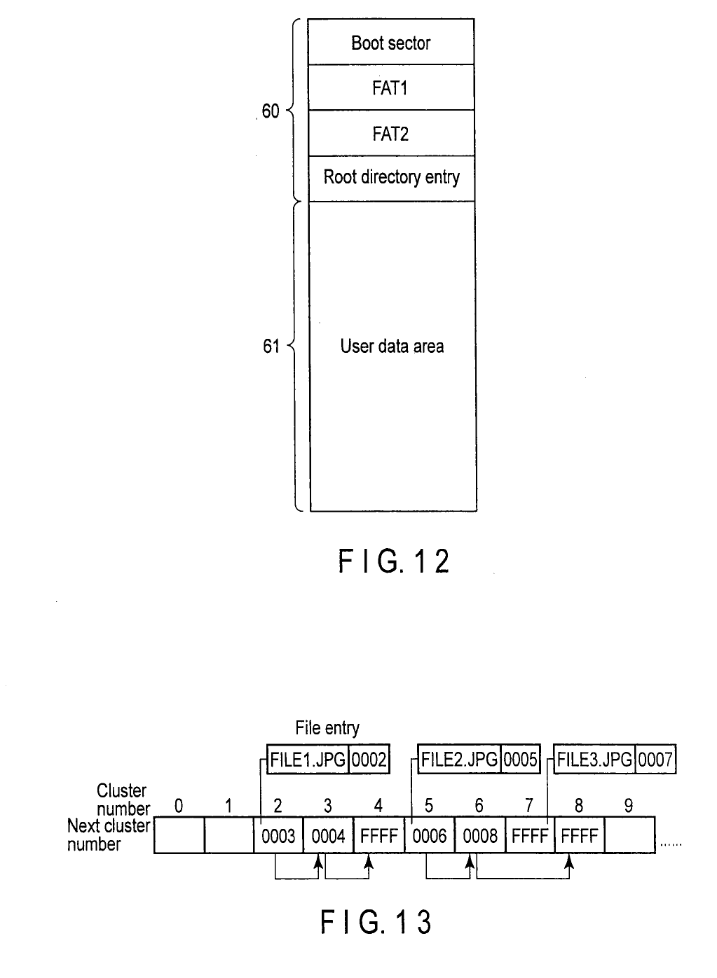

FIG. 12 is a memory map showing a memory space of the memory card 2. The memory space can be roughly divided into a management area 60 and a user data area 61. Each of the areas is divided into units called clusters and thus managed.

The management area 60 is provided to manage files (data) recorded in the NAND flash memory 31, and holds management information for the files. The scheme to manage the files (data) recorded in the memory in this way is referred to as a file system. In the file system, a method of creating directory information such as files and folders, methods of moving and deleting files and folders, data recording schemes, and the place and use of the management area are set. Hereinafter, “0x” added to the head of a number indicates that the subsequent numbers are hexadecimal.

The management area 60 includes, for example, a boot sector, a FAT1, a FAT2, and a root directory entry. The boot sector is an area for storing boot information. The FAT1 and the FAT2 are used to store information regarding which cluster data is stored in. The root directory entry is used to store information on the file located on a root directory. More specifically, the root directory entry is used to store a file name or a folder name, a folder size, attributes, the update date of the file, and information regarding which of the cluster is the head cluster of the file. If the head cluster is known, all the data can be accessed from a FAT chain.

The user data area 61 is an area other than the management area 60, and the capacity that can be stored in the memory card is determined by the size of this area.

Now, the FAT1 and the FAT2 are described. Hereinafter, the FAT1 and the FAT2 are collectively referred to as a FAT. Both the FATs hold the same value, so that the FAT can be restored if one of the FATs is destructed.

The memory space is a set of spaces of a given size called clusters (a set of clusters is an RU, and a set of RUs is an AU). When data to be written is larger than a cluster size, the data is divided into cluster units and thus stored. In this case, a chain of the FATs is created to manage in which cluster the data is written in a divided form.

FIG. 13 shows an example of the FATs and the file entries in the root directory entry. For example, suppose that the root directory includes three files “FILE1.JPG”, “FILE2.JPG”, and “FILE3.JPG” and that the head clusters thereof are “0002”, “0005”, and “0007”.

In the FAT, the number of the cluster to be connected next to each cluster is written. For example, it is known that in the case of “FILE1.JPG”, the cluster to store data following the data in the head cluster “0002” is the cluster “0003”, and the cluster to store data following the data in the cluster “0003” is the cluster “0004”. The file “FILE1.JPG” is restored by connecting the data in the clusters “0002”, “0003”, and “0004”. The FAT indicating the cluster to store the final file data is marked with “0xFFFF”. Whether a cluster is unused can be detected by marking “0x0000”.

Now, the root directory entry is described.

FIG. 14 is a conceptual diagram showing the configuration of the root directory entry. In the example shown by way of example, directories “DIR1” and “DIR2” are created in the root directory entry, and a file “FILE1.MOV” is further created.

As shown, the root directory entry includes a plurality of entries each having 32 bytes. Each entry holds information regarding a file or directory included in the root directory. From the head byte position of the 32 bytes in order, each entry holds the name of the file or subdirectory (DIR Name, 11 bytes), attributes (DIR_Attr, 1 byte), a reservation (DIR_NTRes, 1 byte), creation time (DIR_CrtTimeTenth, 1 byte), creation time (DIR_CrtTime, 2 bytes), creation date (DIR_CrtDate, 2 bytes), last access date (DIR_LstAccDate, 2 bytes), upper two bytes of the head cluster (DIR_FstClusHI), writing time (DIR_WrtTime, 2 bytes), writing date (DIR_WrtDate, 2 bytes), lower two bytes of the head cluster (DIR_FstClusLO), and file size (DIR_FileSize, 4 bytes). The attributes are information that indicates read-only, a directory, a system file, or a hidden file. The one-byte data indicating the reservation are all “0x00”. The creation time (DIR_CrtTimeTenth) indicates a millisecond part of the creation time of the corresponding file or directory, and the creation time (DIR_CrtTime) represents the time in hours and minutes. The head cluster number is divided into the two parts DIR_FstClusHI and DIR_FstClusLO, and recorded in the root directory entry.

For example, in the example shown in FIG. 14, it is known that the file “FILE1.MOV” is present in the root directory, this file is read-only, this file is created on 12:00:15, Dec. 10, 2009, its folder size of 3.50 MB, and its data is written in a cluster 20 at the head. In FIG. 14, entries 0 to 2 are used, and an entry 3 and the following entries are unused. All of the unused entries are set to “0x00”.

The structure of the subdirectory entry is basically the same as that of the root directory entry.

The subdirectory entry is different from the root directory entry in that the subdirectory entry includes a dot (.) entry indicating this subdirectory entry and a dot-dot (. .) entry indicating the parent directory. The subdirectory entry is provided in the user data area 61 in FIG. 12.

### 3.2 Regarding a Specific Example

Now, details of the data erasing and overwriting (updating) operations are described below.

### 3.2.1 Data Deletion (First Deleting Example)

When a file is deleted, the reuse of its areas accelerates the fragmentation of data. Therefore, the dedicated file system manages a memory space in accordance with the method that does not allow the deleted area to be immediately reused. For example, when there is a shortage of areas, garbage collection is performed by given timing, and areas that can be secured as free AUs among the unused areas are reused.

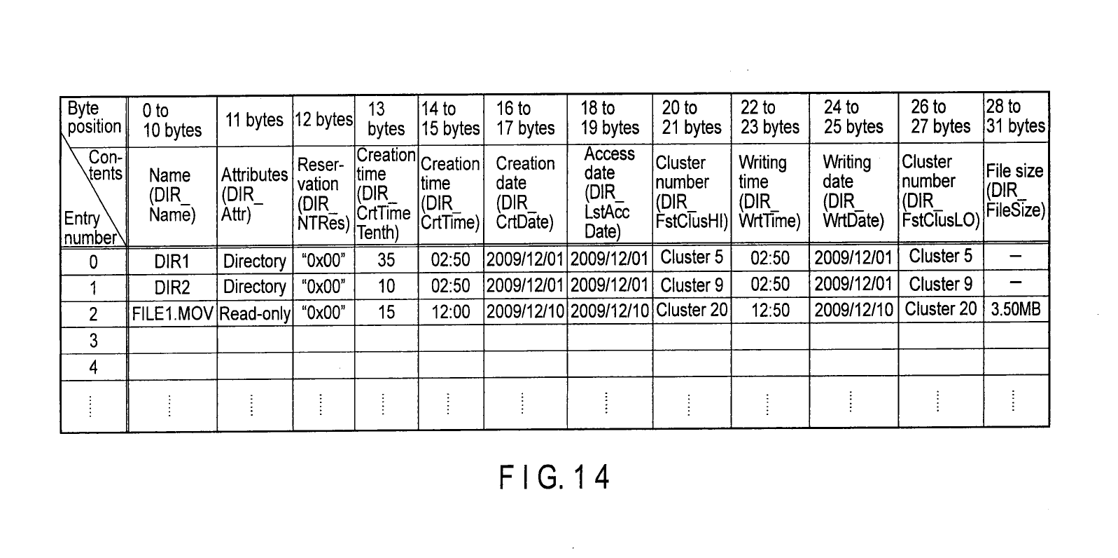

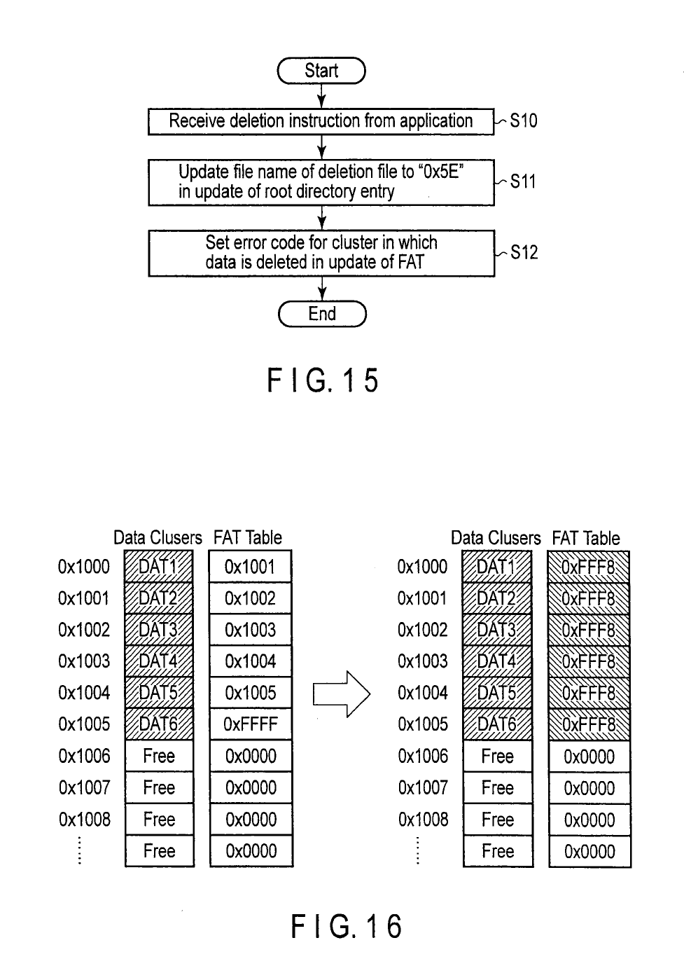

First, the deletion of data is described with reference to FIG. 15. FIG. 15 is a flowchart showing the flow of the operation of the dedicated file system.

As shown, the dedicated file system receives a file deletion instruction from the application 50 (step S10). As the processing of this instruction, the dedicated file system updates the head byte (zeroth byte) of the file name or directory name (name field in FIG. 14) of the directory entry to a deletion code (e.g. “0x5E” (step S11). An error code is then set in the FAT corresponding to the data cluster which holds the file to be deleted (step S12). As a result, the reuse of the cluster holding the file data to be deleted will be prohibited in the future.

FIG. 16 shows a specific example of the clusters and the FATs when data is deleted, and shows the clusters and the corresponding FATs. In FIG. 16, the shaded parts of the clusters indicate the areas to hold data, and the shaded parts of the FATs indicate that the FATs have been updated.

As shown in the left part of FIG. 16, data DAT1 to DATE are respectively held in, for example, the clusters having the cluster numbers “0x1000” to “0x1005”. These DAT1 to DAT6 are sequentially linked by the FATs to form one file.

The right part of FIG. 16 shows the state when the file is deleted. As shown, all the FATs corresponding to the clusters holding the data DAT1 to DAT6 to be deleted are updated to “0xFFF8” indicating error codes. However, the data DAT1 to DAT6 itself are not deleted from the clusters and remain held in the clusters.

### 3.2.2 Data Deletion (Second Deleting Example)

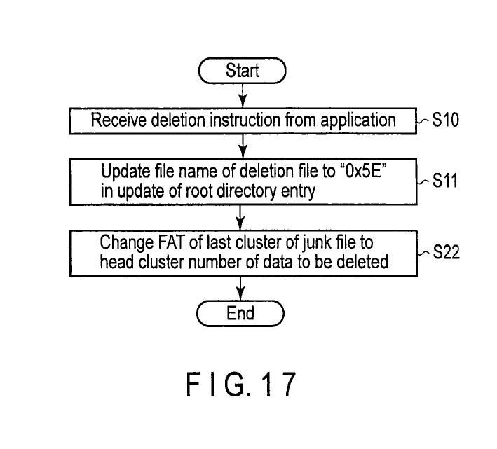

Now, another example of data deletion is described with reference to FIG. 17. FIG. 17 is a flowchart showing the flow of the operation of the dedicated file system.

As shown, steps S10 and S11 are similar to those in FIG. 15, and step S22 is performed instead of step S12. That is, in step S22, the dedicated file system links data to be deleted to an existing junk file. More specifically, the FAT of the last cluster corresponding to the existing junk file is updated to a head cluster number of deletion file data from “0xFFFF” (step S22). The junk file means an unnecessary file, and is a file created not by the application 50 but by the dedicated file system.

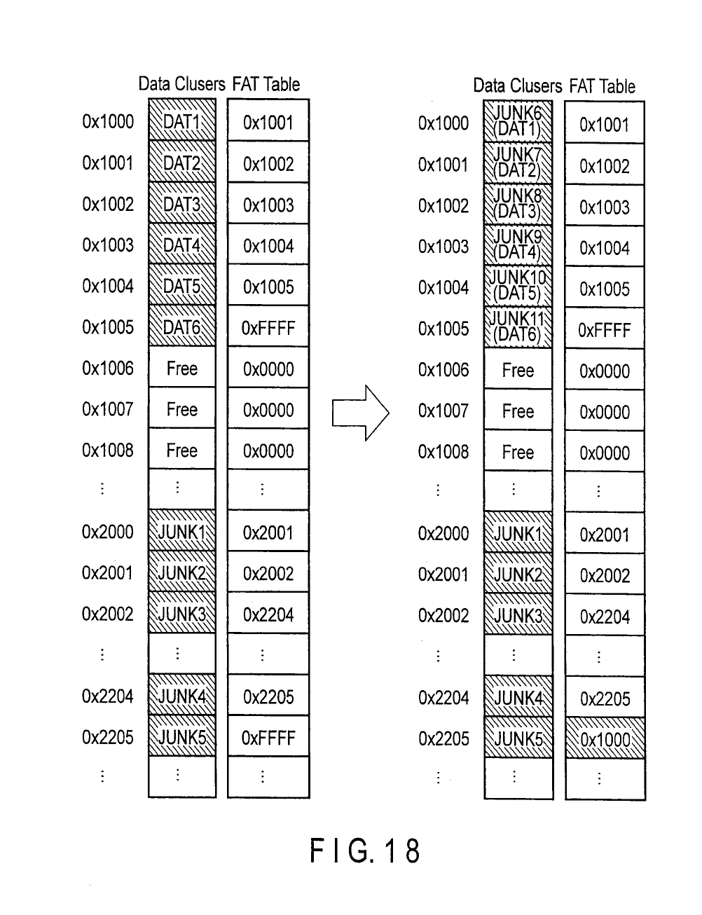

FIG. 18 shows a specific example of the present embodiment, and shows the clusters and the corresponding FATS. In FIG. 18, the shaded parts of the clusters indicate the areas to hold data, and the shaded parts of the FATs indicate that the FATs have been updated.

As shown in the left part of FIG. 18, data DAT1 to DAT6 are respectively held in, for example, the clusters having the cluster numbers “0x1000” to “0x1005”. These DAT1 to DAT6 then sequentially linked by the FATs to form one file. Moreover, junk data JUNK1 to JUNK5 are respectively held in, for example, the clusters having the cluster numbers “0x2000” to “0x2002” and “0x2204” to “0x2205”. These JUNK1 to JUNK5 are sequentially linked by the FAT to form junk file. The group of clusters having the cluster numbers starting from “0x1000” and the group of clusters having the cluster numbers starting from “0x2000” belong to different AUs.

The right part of FIG. 18 shows the state when the file which is formed by the data DAT1 to DAT6 is deleted. As shown, the FATs corresponding to the clusters holding the data DAT1 to DAT6 to be deleted are not rewritten, and the FAT corresponding to the cluster holding the data JUNK5 of the existing junk file is updated to “0x1000”. As a result, the data DAT1 to DAT6 are linked to the end of the data JUNK5. Thus, the data DAT1 to DAT6 remain in the memory card 2 as junk files.

### 3.2.3 Data Overwriting (First Overwriting Example)

The dedicated file system manages a memory space in accordance with the method that does not allow the deleted area to be immediately reused in the overwriting of data as well.

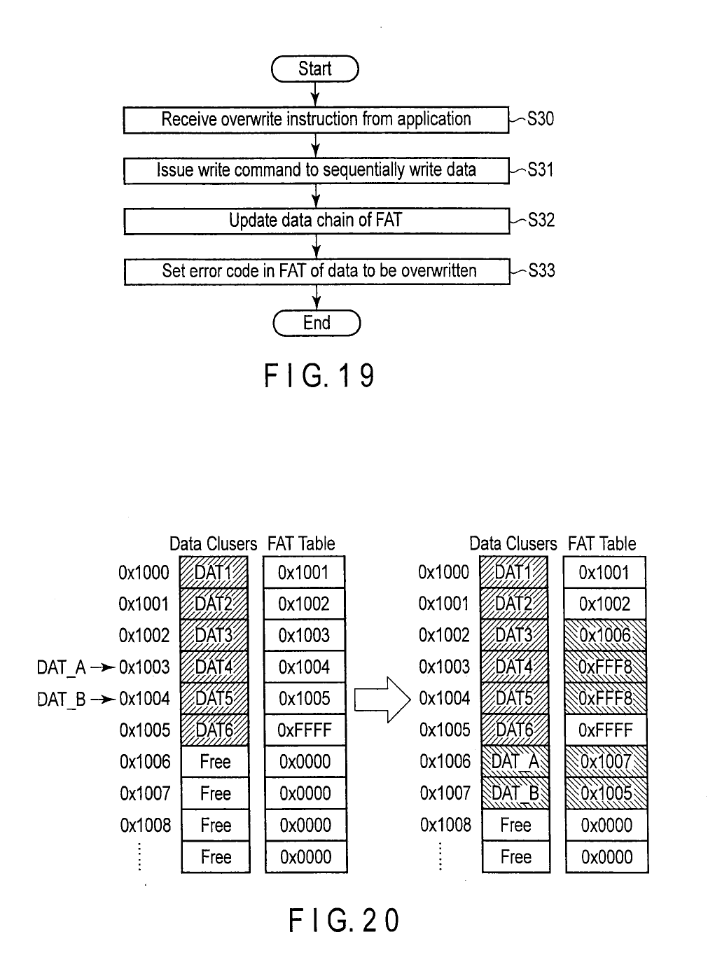

Now, data overwriting (updating) is described with reference to FIG. 19. FIG. 19 is a flowchart showing the flow of the operation of the dedicated file system.

As shown, the dedicated file system receives a data overwrite instruction from the application 50 (step S30). The dedicated file system does not overwrite data, but sequentially writes data in a free space following the already written data. That is, the dedicated file system issues a data write command including the write address in its argument to the memory card 2 (step S31).

In response to the write command, the memory card 2 sequentially writes data. The dedicated file system updates the FAT to replace the cluster chain of the file data with overwrite data (step S32). In order to prevent the use of the data to be overwritten, an error code is set in the FAT corresponding to this data (step S33). When the AU which has already been reserved can be used for overwriting, the remaining capacity does not change. However, when there is a shortage of areas to overwrite data, new free AUs are reserved, so that the remaining capacity decreases.

FIG. 20 shows a specific example of the clusters and the FATs when data is overwritten, and shows the clusters and the corresponding FATs. In FIG. 20, the shaded parts of the clusters indicate the areas to hold data, and the shaded parts of the FATs indicate that the FATs have been updated.

As shown in the left part of FIG. 20, data DAT1 to DAT6 are respectively held in, for example, the clusters having the cluster numbers “0x1000” to “0x1005”. These DAT1 to DAT6 are sequentially linked by the FAT to form one file.

The right part of FIG. 16 shows the state when the DAT4 and the DAT5 among the above data items are respectively overwritten by DAT_A and DAT_B. As shown, the FATs corresponding to the clusters holding the data DAT4 and DAT5 to be overwritten are updated to “0xFFF8” indicating all error codes. However, the data DAT4 and DAT5 itself are not deleted from the clusters and remain held in the clusters. The FAT corresponding to the DAT3 is updated to “0x1006”, and “0x1007” and “0x1005” are respectively set in the FATs corresponding to the DAT_A and DAT_B. As a result, the DAT3 is linked to the DAT_A, and the DAT_B is linked to DAT6.

### 3.2.4 Data Overwriting (Second Overwriting Example)

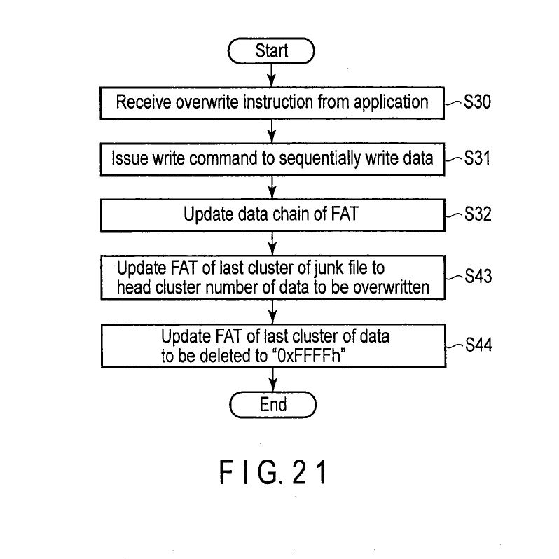

Now, another example of data overwriting (updating) is described with reference to FIG. 21. FIG. 21 is a flowchart showing the flow of the operations of the host apparatus 1 and the memory card 2.

As shown, the processing in steps S30 to S32 described in FIG. 19 is performed. The dedicated file system then updates the FAT of the last cluster corresponding to the existing junk file to a head cluster number corresponding to the data to be overwritten from the last cluster number “0xFFFF” (step S43). The dedicated file system further updates the FAT of the last cluster of the data to be overwritten to “0xFFFF” (step S44).

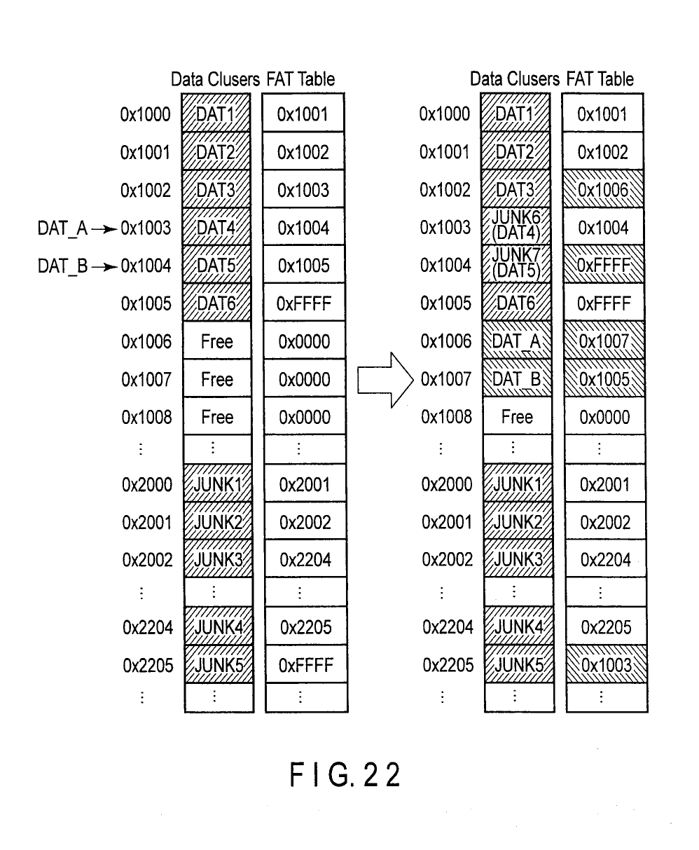

FIG. 22 shows a specific example of the present embodiment, and shows the clusters and the corresponding FATs. In FIG. 22, the shaded parts of the clusters indicate the areas to hold data, and the shaded parts of the FATs indicate that the FATs have been updated.

The left part of FIG. 22 shows the state before the overwriting of data, and is similar to that in FIG. 18. Suppose that the data DAT4 and DAT5 are overwritten by the DAT_A and DAT_B in this state. This state is shown in the right part of FIG. 22. As shown, the data JUNK5 is linked to the data DAT4 to be overwritten, and the FAT corresponding to the data DAT5 is updated to “0xFFFF”. As a result, the data DAT4 and DAT5 to be overwritten are linked to the junk file.

### 3.3 Advantageous Effects According to the Present Embodiment

According to the data deleting and overwriting method of the present embodiment, data is not overwritten in effect. For the data area, the dedicated file system executes sequential writing which is suited to the flash memory and does not delete data so that the generation of fragmentation areas can be inhibited. These advantageous effects are described below.

According to the method described in the section 3.2.1, when the application 50 requests the deletion of data, the dedicated file system does not delete data itself from the cluster, and rewrites the value of the corresponding FAT to an error code. According to the method described in the section 3.2.3 as well, the dedicated file system does not delete the data to be overwritten from the cluster, and rewrites the value of the corresponding FAT to an error code.

That is, according to the present method, unnecessary data remains in the cluster, and this cluster does not become a free area. Instead, an error code is stored in the FAT corresponding to this FAT. Therefore, it is possible to prevent the cluster corresponding to the unnecessary data from being again selected as an area to write new data.

According to the method described in the section 3.2.2, the dedicated file system leaves the data to be deleted data in the cluster as a junk file. If there is an existing junk file, the data is linked to this junk file (if there is no existing junk file, the data is naturally not linked, and the deleted file is treated as a junk file). According to the method described in the section 3.2.4 as well, the dedicated file system leaves the data to be overwritten as a junk file.

According to the present method as well, it is possible to prevent the cluster corresponding to the unnecessary data from being again selected as an area to write new data. The following advantageous effects are obtained by leaving unnecessary data as a junk file. The application 50 may have a function such as a check disk command to check and correct an error in a memory space. Accordingly, the error code of the FAT is cleared by this command, and this cluster may be available as a free cluster. However, such a situation can be prevented if the data is left as a junk file.

In the example shown in FIG. 18, the cluster of “0x2205” has only to be updated, and it is not necessary to update all the FATs of the clusters to be deleted as in the example shown in FIG. 16. Thus, this technique can be said to be a simpler technique.

According to any of the methods, fragmentation is inhibited, and data can be sequentially written. Moreover, according to any of the methods, the free space of the memory card 2 does not increase even if the application 50 deletes data. Therefore, if the deletion and overwriting of data are repeated, the memory card 2 may have a little free space, and most of the memory card 2 may be filled with unnecessary data (clusters with FATs of error codes, junk files). In this case, for example, the dedicated file system may monitor the use of the memory card 2, and perform garbage collection by proper timing.

That is, by the garbage collection, effective data scattered in a plurality of blocks in the NAND flash memory 31 are collectively copied to a certain physical block, and the physical block from which the data are copied is erased to generate a new free AU. The error code of the FAT is cleared by this garbage collection, and a plurality of fragmentation areas are combined into a sequentially writable area. It goes without saying that the cluster in which an error code is set to the FAT can be reused by formatting the memory card

2. In the example in which the junk file is used, a data chain of the junk files is reconstructed without reusable clusters.

The place where a file is recorded is indicated in the directory entry. However, the file name of the file to be deleted can be updated to “0xE5” to invalidate this entry. It is preferable that the junk files described with reference to FIG. 18 and FIG. 22 should be hidden files so that these files may not be recognized by the user of the host apparatus 1. Moreover, the files are combined into one junk file in the examples described above. Otherwise, the names of the files to be deleted may be individually changed to leave the files as a plurality of junk files.

Although the FAT corresponding to the cluster holding unnecessary data is updated to an error code (e.g. “0xFFF8”) in the example described according to the methods in the section 3.2.1 and 3.2.3, the FAT may be updated to the last cluster number (e.g. “0xFFFF”) of the FAT chain. It should be understood that the codes are not limited to the above-mentioned codes if the codes signify the prohibition of use in the file system.

### 4. Fourth Embodiment

Now, a host apparatus according to a fourth embodiment is described. The present embodiment concerns the directory entry creation method in the first to third embodiments. The differences between the first to third embodiments and the present embodiment are only described below.

### 4.1 Regarding the Characteristics of the NAND Flash Memory and the Initialization of the Directory Entry

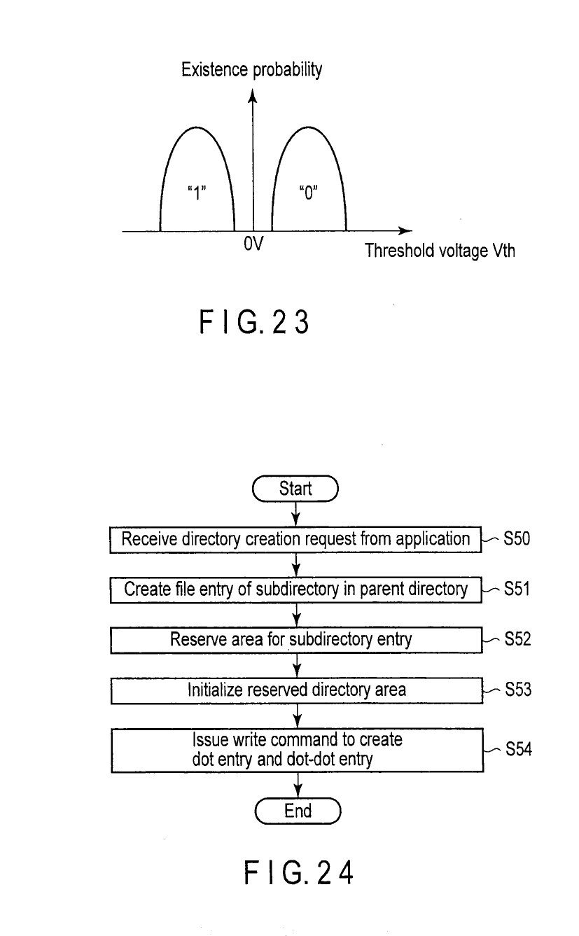

FIG. 23 shows a threshold distribution of the memory cell of the NAND flash memory. The memory cell (single level cell) shown by way of example is capable of holding two values.

As shown, the memory cell can take two states: state with a negative threshold and a state with a positive threshold. Herein, these states are respectively defined as data “1” and data “0”. The memory cell is holding the data “1” in an erased state, and shifts the state to hold the data “0” when data is written.

FIG. 24 is a flowchart showing of the operation of a conventional file system when a directory entry is newly created. As shown in FIG. 24, the conventional file system first receives a directory creation request from the application 50 (step S50). In response to this request, the file system creates a file entry of a subdirectory in a parent directory (step S51), reserves an area of the subdirectory entry (step S52), and initializes the reserved directory area by the data “0” (step S53). The file system then creates file entries for “. . (dot-dot)” and “. (dot)” (step S54). However, step S53 and step S54 can be combined into one writing step.

As described above, particularly in step S53, the file system needs to write data of all “0s” into the first one cluster of the entries for the “initialization of the directory entry”. This is because the head byte “0” of each entry indicates that the entry of the directory entry is free (i.e. the entry is not used). The file system overwrites the directory entry after the initialization. Therefore, the problem is that the writing of the file entry results in the overwriting of the flash memory.

### 4.2 Regarding the Improvement of Directory Entry Creation

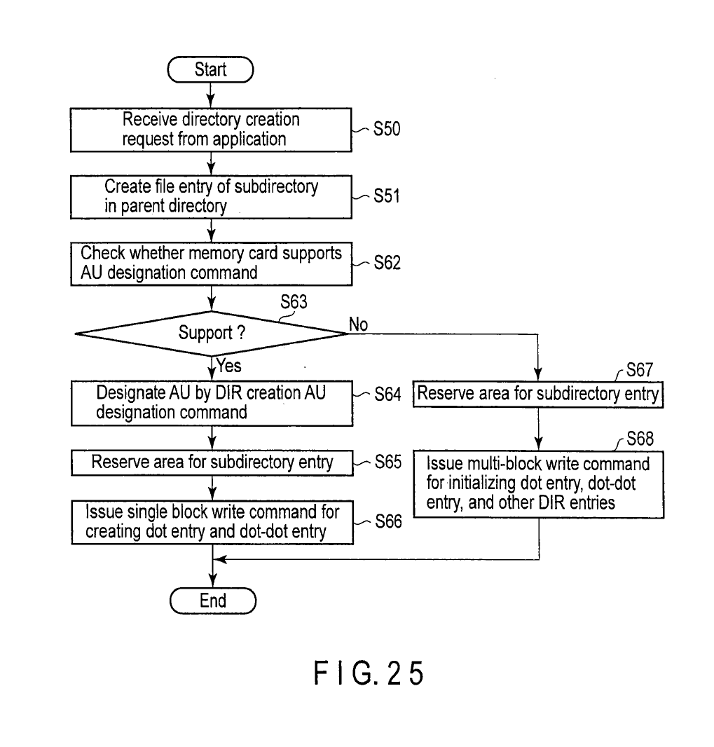

The flow of processing performed by the dedicated file system is shown in FIG. 25. The differences between FIG. 25 and FIG. 24 are as follows.

As shown, the dedicated file system checks whether the card supports the DIR creation AU designation command (Set DirE AU) after steps S50 and S51 (step S62). When the card supports the command (step S63, YES), the dedicated file system issues the DIR creation AU designation command and designates an AU if the dedicated file system has not designate an AU to create a subdirectory (step S64). Within the designated AU, a place to create the subdirectory is determined (step S65). The dedicated file system issues a directory creation command without initializing the directory entry (step S65). Further, the dedicated file system issues a single block write command for creating “. .” and “.” (step S66).

When the card does not support the DIR creation AU designation command (step S64, NO), the dedicated file system determines a place to create the subdirectory entry (step S67). Further, the dedicated file system issues a multi-block write command for initializing the file entries for “. .” and “.” and other DIR Entry data to “0” (step S68).

When the card receives the DIR creation AU designation command, the AU area is initialized within the card before the writing of the following file entry (step S66), and then the file entry is written. As a result, the dedicated file system does not need to initialize the directory entry, and can perform processing so that the writing of the first file entry may not be the overwriting of the flash memory.

Two examples are shown below as the methods of processing the memory card 2 for step S68.

### 4.2.1 Regarding the Operation of the Memory Card 2 (First Example)

The controller 32 receives the DIR creation AU designation command from the dedicated file system of the host apparatus 1. This command corresponds to “Set DirE AU” in FIG. 10 described in the first embodiment. The controller 32 then reserves, as an area to create a directory entry, the AU specified by the address of the memory access command following the DIR creation AU designation command. The controller 32 then ensures that data in the area of the reserved one cluster will be “0”. The controller 32 does not always need to write the data “0”. According to this method, the card needs to recognize the cluster length.

### 4.2.2 Regarding the Operation of the Memory Card 2 (Second Example)

While the conventional file system reserves the directory entry by the cluster unit, the second example reserves the directory entry area by the AU unit. This area can be more efficiently initialized by using an erasing command supported by the NAND flash memory 31 than by writing the data “0”. However, erasing by the erasing command results in a level “1” of data in the NAND flash memory. Therefore, the data needs to be designed to seem “0” when seen from the host.

The controller 32 inverts the data received from the host apparatus 1 and then writes the inverted data into the NAND flash memory 31. The controller 32 also inverts the data read from the NAND flash memory 31 and then transmits the inverted data into the host apparatus 1. Thus, when the flash memory holds the data “1” in an erased state, the controller 32 inverts the data during reading, so that the host apparatus 1 recognizes that the directory entry is holding the data “0”. According to this method, when receiving the DIR creation AU designation command (Set DirE AU), the controller 32 of the card first uses the erasing command of the flash memory to initialize the AU by the data “0”. Therefore, this example is different from the first example in that the cluster size does not to be recognized, in that the erasing function of the flash memory can be used for high-speed erasing, and in that overwriting can be easily avoided. Thereafter, the dedicated file system reserves this AU for the directory entry to ensure that the initial value is “0”, and the initialization is therefore not needed even when a new directory entry is created.

### 4.3 Advantageous Effects According to the Present Embodiment

In the FAT file system, when a directory entry is created, its cluster can be used after initialized to the data “0”. Therefore, the host apparatus needs to write the data “0” so that one cluster area of the reserved directory entry will be in an erased state. Another problem is that the file entry is written after the writing with “0” so that this writing results in overwriting. In the case of overwriting, a card controller requires a certain amount of processing time, and it is therefore preferable that there is no overwriting for the initialization.

According to the present embodiment, the directory entry initialization function is provided in the memory card 2. Therefore, the host apparatus 1 does not need to perform the initialization operation, and the load on the host apparatus 1 can be reduced. Whether the memory card 2 has the initialization function can be recognized, for example, by reference to the register 46. Accordingly, the host apparatus 1 can determine whether to initialize the directory entry.

In the method described in the section 4.2.2, the memory card 2 does not need to recognize the cluster size and the high-speed erasing function of the flash memory can be used. That is, the directory entry has heretofore been created in any of the free clusters. That is, one cluster becomes the directory entry. Therefore, in order to initialize the whole area of one directory entry, it is necessary to recognize the size of one cluster. However, according to the method in the section 4.2.2, the dedicated file system reserves an AU for the directory entry, and the memory card 2 initializes by the AU unit, so that it is not necessary to recognize the cluster size.

### 5. Fifth Embodiment

Now, a host apparatus according to a fifth embodiment is described. The present embodiment concerns the API in the first to fourth embodiments. The differences between the first to fourth embodiments and the present embodiment are only described below.

### 5.1 Regarding the Basic APIs 55 and 57

The functions of the basic APIs 55 and 57 are first described. The basic APIs 55 and 57 have the following functions.

(a) GetDriveProperties: a function to acquire the properties of a target drive. For example, information regarding whether a storage device has the functions according to above embodiments ca be acquired by “GetDriveProperties”.

(b) Open: a function to open a file and acquire its file handle.

(c) Write: a function to write a file.

(d) Read: a function to read data.

(e) Seek: a function to move a file pointer.

(f) Close: a function to close the file handle.

(g) MoveFile: a function to move or rename a file.

(h) CopyFile: a function to copy a file.

(i) DeleteFile: a function to delete a file.

(j) GetFileProperty: a function to acquire the properties of a file.

(k) CreateDir: a function to create a directory.

(l) DeleteDir: a function to delete a directory.

(m) MoveDir: a function to move or rename a directory.

### 5.2 Regarding the Extended API 56

Now, the functions of the extended API 56 are described. The extended API 56 preferable has at least one of the following functions.

(n) Acquisition of a free AU: a function to search for a free place (i.e. unused area, or empty area) by the AU unit, and to return its head address.

(o) Creation of a directory entry: a function to reserve an AU for the management of the directory entry and create a new directory entry in the free cluster of this AU.

(p) Update of a directory entry: a function to designate an area to write a file entry and update the area. For the updating, repeated writing is possible in the same area.

(q) Writing of data: a function to sequentially write data in the AU.

(r) Deletion of an unreleased area: an area after deletion is released in a general deletion API (i.e. released area may be reused), but the area is kept unused in the extended API, that is, the area is not released. More specifically, this is the deleting and overwriting method described in the third embodiment. The method of managing the unused area includes the following two examples (the method that marks with a special code and the method that uses the junk file, as has been described in the third embodiment).

(s) Format: a function to release a cluster which is kept unused by the special code as a free cluster when the card is formatted. The cluster which is kept unusable by the special code is, for example, a cluster managed by the error code described in the third embodiment. Moreover, when the junk file is used, the junk file is erased and erased area is released to a free area.

(t) Acquisition of the remaining capacity: the remaining capacity is also calculated by the AU unit in the memory managed by the AU unit. This is a calculation method that does not include fragmented areas and unused area.

### 5.3 Advantageous Effects According to the Present Embodiment

When the extended API is used as in the present embodiment, information that cannot be processed by the conventional basic API can be accessed by the application 50.

As has been described in the first embodiment, the application 50 can carry out the first to fifth embodiments without knowing information such as the AU size and the Speed Class. However, the extended API provides the application 50 with the functions which are not included in the basic API so that the degree of freedom in the development of the application 50 can be improved.

### 6. Sixth Embodiment

Now, a host apparatus according to a sixth embodiment is described. The present embodiment concerns the operation when a plurality of files are simultaneously written into the memory card in the first to fifth embodiments. The differences between the first to fifth embodiments and the present embodiment are only described below.

### 6.1 When a Single Stream Function is Used

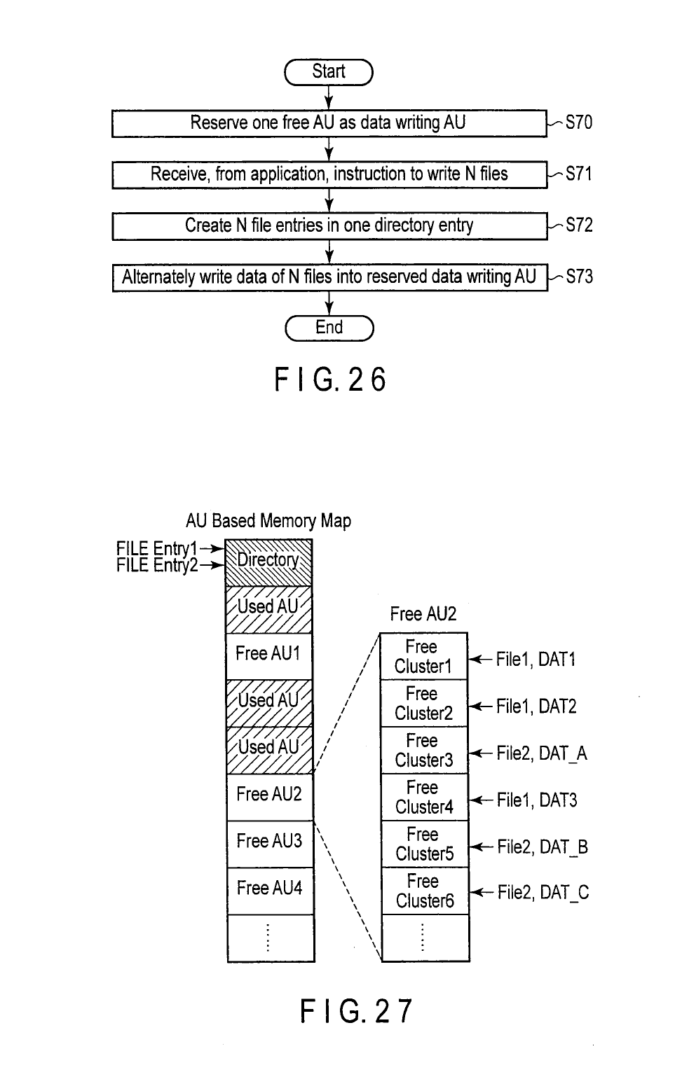

The use of the single stream function of the memory card 2 is first described with reference to FIG. 26. FIG. 26 is a flowchart showing the operation of the dedicated file system.

As shown, the dedicated file system assumes that a plurality of files (N files, N is a natural number equal to or more than 2) that are simultaneously created are created in the same directory, and assumes that the N files can use the same directory entry. The dedicated file system reserves one AU for data writing regardless of N (step S70). The dedicated file system then receives, from the application 50, an instruction to write N files (step S71). The dedicated file system then creates N file entries corresponding to the respective N files in the same directory entry (step S72). The dedicated file system continuously writes N file data into the reserved AU in a divided form (step S73). The size of each file is determined, for example, by the bit rate of each file.

FIG. 27 shows a memory map according to the present embodiment. In FIG. 27, the host apparatus 1 creates two file entries (File_Entry1, File_Entry2) in the memory card 2, creates information (e.g. the name, attributes, the start position of a data cluster) regarding a file 1 in a file entry 1, and also creates information regarding a file 2 in a file entry 2.

The dedicated file system creates the file entry 1 (File_Entry1) and the file entry 2 (File_Entry2) in the same directory entry.

Furthermore, the dedicated file system reserves a free AU2 for storing data in the two files (File1, File2). The dedicated file system then sequentially writes in the File1 and File2 into the reserved AU2.

In FIG. 27, DAT1, DAT2, DAT3, . . . are the data of the File1, and DAT_A, DAT_B, DAT_C, . . . are the data of the File2. The dedicated file system writes these data items into the memory card 2 in a divided form. In this case, data of any size are written in any order, but the size and the order are generally determined in consideration of the bit rate. A real-time recording method disclosed in previously mentioned U.S. Pat. No. 7,953,950 can be used as a method of writing data into each AU.

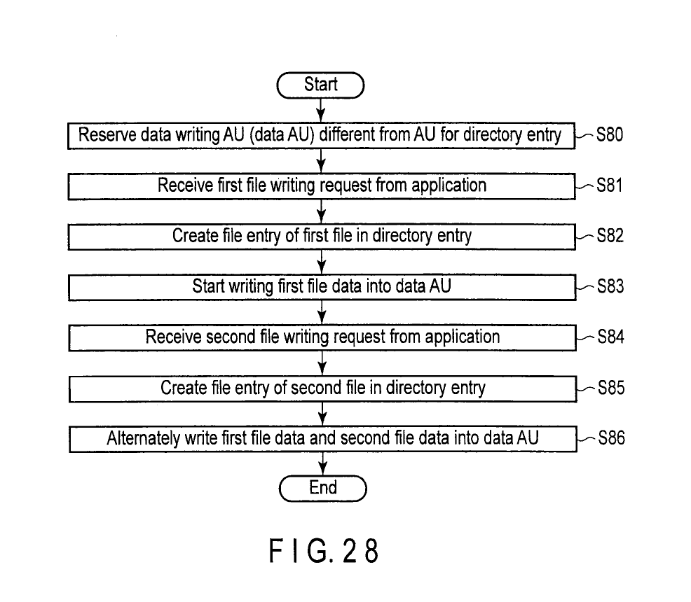

FIG. 28 is a flowchart more specifically showing the flow of processing performed by the dedicated file system to simultaneously write two files (a first file and a second file) into the memory card 2. In the example shown in FIG. 28, the dedicated file system receives an instruction to write the second file during the writing of the first file.

As shown, the dedicated file system reserves a free AU different from the DIR Entry as one data writing AU (step S80). The dedicated file system also receives, from the application 50, a request to, for example, create the first file and write data (step S81). The dedicated file system registers first file information in the directory entry (step S82), and starts writing the data of the first file into the data writing AU (step S83). The dedicated file system then receives, from the application 50, a request to, for example, create the second file and write data (step S84). The dedicated file system registers second file information in the directory entry (step S85), and sequentially writes the data of the first file and the second file into the data writing AU in a divided form (step S86). The order and size of the divided write data are determined on the basis of, for example, the write bit rate of the file data.

### 6.2 Advantageous Effects According to the Present Embodiment

At present, the NAND flash is widely used as a recording medium for music data or image data. Recording media are used in diversified ways. For example, there have been demands that two television programs can be recorded in parallel and that a still image can be acquired during moving image photography. If the conventional file system is used to fulfill these demands, data copying operation is required in the NAND flash memory, and the writing speed deteriorates. This is attributed to the fact that data cannot be overwritten in the NAND flash memory.

In this respect, in the configuration according to the present embodiment, data is sequentially written into the AU even when a plurality of files are recorded into the memory card. Therefore, data can be written by the optimum method for the NAND flash memory, and the performance of the memory card 2 can be maximized.

### 7. Seventh Embodiment

Now, a host apparatus according to a seventh embodiment is described. According to the present embodiment, the operations described in the first, third, and fourth embodiments are enabled by the host apparatus which does not have the extended API described in the first and second embodiments. The differences between the previous embodiments and the present embodiment are only described below.

### 7.1 Regarding the Configuration of the Host Apparatus 1

The host apparatus 1 according to the present embodiment has a configuration in which the extended API 56 in FIG. 2 described in the first embodiment is eliminated.

### 7.2 Regarding the Operation of the Host Apparatus 1

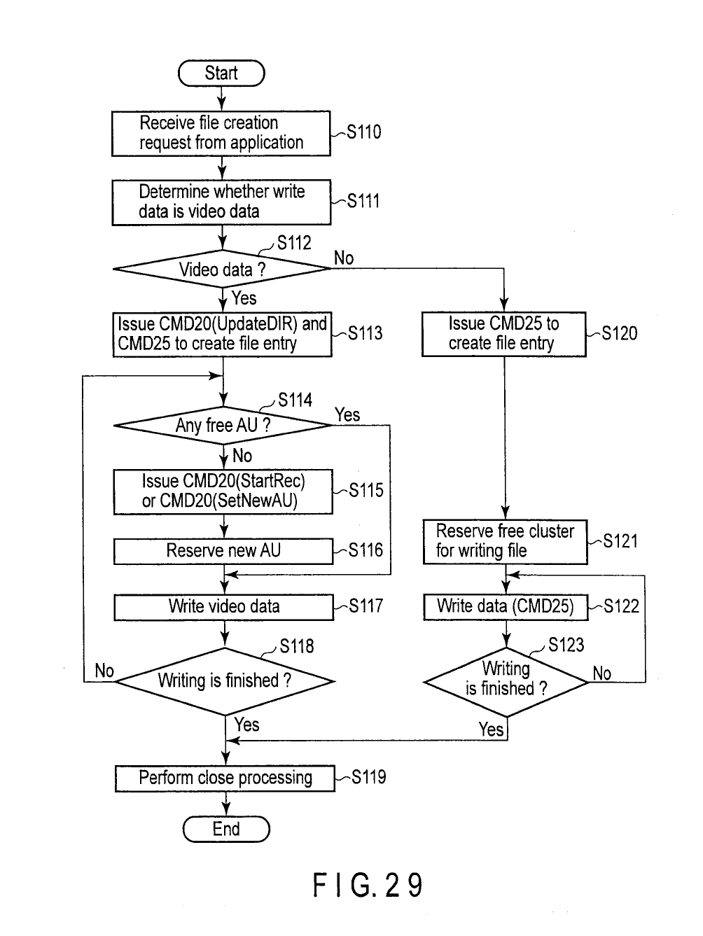

Now, the operation of the host apparatus 1 according to the present embodiment is described with reference to FIG. 29. FIG. 29 is a flowchart showing the flow of processing particularly in the dedicated file system of the host apparatus 1.

(1) File Creation Request

As shown in FIG. 29, the dedicated file system first receives from the application 50 a file creation request directed to the memory card 2 (step S110). This request is made, for example, by the use of the file open function in the basic API 55.

(2) Determination of File Attributes

The dedicated file system then acquires a free space to write data. The place to write the data is determined on the basis of free area information (the FAT or bitmap). In this case, the dedicated file system determines whether data attributes included in the file creation request from the application 50 are video data (step S111), and the dedicated file system changes the free space acquiring method accordingly. The determination in step S111 can be made by file extension information in the file entry. More specifically, it is possible to identify, for example, by the extension of the file. If the extension of the file is a video file attribute such as “MP4” or “MOV”, it is possible to determine that the file is video data. Alternatively, a special bit indicating that the file is a video file is provided in the directory entry, and a determination may be made by this bit.

When write data is video data (step S112, YES), the dedicated file system selects an algorithm to reserve an area by the AU unit, such as the algorithm described in the first to sixth embodiments (more specifically, step S116 described later). That is, the dedicated file system recognizes the AU size, searches for an entirely free space by the AU size unit from the FAT (or bitmap), and selects one of the found areas as an area to write the video data. This algorithm is the free AU write algorithm described with reference to FIG. 6.

On the other hand, if the write data is not video data (step S112, NO), the dedicated file system selects an algorithm which is used in normal file systems and which writes data in fragmented areas (more specifically, step S121 described later). This algorithm is the fragmented AU write algorithm described with reference to FIG. 6.

The video data is shown by way of example. It is also possible to select an algorithm that reserves an area by the AU unit if an extension name of file indicates that the file may have heavy data (e.g. a JPG file). Alternatively, the total data length of the file is acquired from the application, and this size can be used to determine an algorithm (the already written data length is recorded in the file entry, and therefore the total data length cannot be known from here). Whether the data size is large or small can be determine, for example, by the threshold previously saved in the dedicated file system. When the data size is not determined yet, whether a file attribute is likely to have heavy data can be recognized by file entry information in the directory entry.

The algorithms may be selected based on whether the file is expected to be overwritten or not, in addition to the data size. For example, when the file has large data or is unexpected to be overwritten, the Free AU write algorithm may be selected. In contrast, when the file has small data or is expected to be overwritten, the Fragmented AU write algorithm may be selected. The dedicated file system may be determine, from the file attribute, whether the file is expected to be overwritten

(3) Creation of File Entry

The dedicated file system then creates a file entry, and writes the created file entry into the memory card 2 (step S113).

When write data is video data (step S112, YES), the dedicated file system issues a DIR update command (“CMD20 Update DIR”) to notify the memory card 2 that the next write data is the file entry, and then issues a CMD25 to write the file entry into the memory card 2 (step S113). As has been described with reference to FIG. 14, the file entry includes, for example, a file name, an extension, and data record position information (head address) acquired in step S113.

When the write data is not video data, the CMD20 is not issued (step S120).

(4) Reserving of a Free Area and Writing of Data

Data is then written into the memory card 2. When write data is video data (step S112, YES), the dedicated file system checks whether there is any free area to write into, in response to a data write request from the application 50 (step S114). When a data writing AU is already reserved, the following data is sequentially written. When no data writing AU is reserved or when the reserved AU has no free space, the dedicated file system issues “CMD20 Start Rec” or “CMD20 Set New AU” (step S115), and a free AU is reserved (step S116). The data is sequentially written into the reserved AU (step S117). The flow returns to step S114 until writing is completed (step S118). When data is written in all the areas of the AU, the dedicated file system reserves another free AU in accordance with the free AU write algorithm, and sequentially writes data into the newly reserved free AU. The order of the written data is recorded as a FAT chain. In the data writing, the dedicated file system inserts a cycle to update the FAT at regular time intervals or at intervals of a given written data size.

When the write data is not video data (step S112, NO), the dedicated file system reserves a free cluster necessary for the file (step S121), writes data by the CMD25, records the order of the written data as a FAT chain (step S122), and repeats the flow until writing is completed (step S123). The CMD20 is not used in step S120 to step S123.

(5) Termination Processing

In close processing requested by the application 50, the dedicated file system performs processing to close the file (step S119). Information such as the sizes of the data so far recorded and update dates is recorded in the file entry. When data is continuously written into the same file, this file is reopened by the Append Mode. This is based on the assumption that the control does not affect Speed Class writing.

### 7.3 Advantageous Effects According to the Present Embodiment

According to the method described in the present embodiment, the extended API 56 is not needed, and the operations according to the first to sixth embodiments can be performed. The application 50 does not need to recognize the Speed Class of the memory card 2 and the AU size.

### 8. Modifications, etc.

As described above, the host apparatus according to the first to seventh embodiments is a host apparatus to access a memory device, and includes the application software (the application 50 in FIG. 2), the dedicated file system (the unit 51 and the file system 52 in FIG. 2), and the interface circuit (the I/F 59 in FIG. 2). The application software 50 issues a memory device access request to the dedicated file system. The access request includes, for example, the file open, the file data write, and the file close. The dedicated file system (51 and 52) controls access to the memory device in response to an access request. The interface circuit 59 accesses the memory device under the access control by the dedicated file system (51 and 52). The dedicated file system (51 and 52) manages the logical address spaces of the memory device by the predetermined unit area AU, and sequentially writes data into any of the reserved unit areas AU. The sequential writing into the unit areas AU is executed by one or more write commands (CMD25). The application software 50 issues the access request to the dedicated file system (51 and 52) without recognizing a unit area AU size.

According to this configuration, the dedicated file system manages the memory device 2 by the AU unit, and sequentially writes data. Therefore, the application 50 is capable of high-speed writing operation without recognizing the AU size.

Various modifications can be made to the first to seventh embodiments described above. The allocation unit (AU) herein is a management unit of the memory device on a logical space, and is a unit defined as a Speed Class of the SD memory card. A value can be read from the register of the memory card. The AU boundary is associated with a logical block boundary of the NAND flash memory 31.

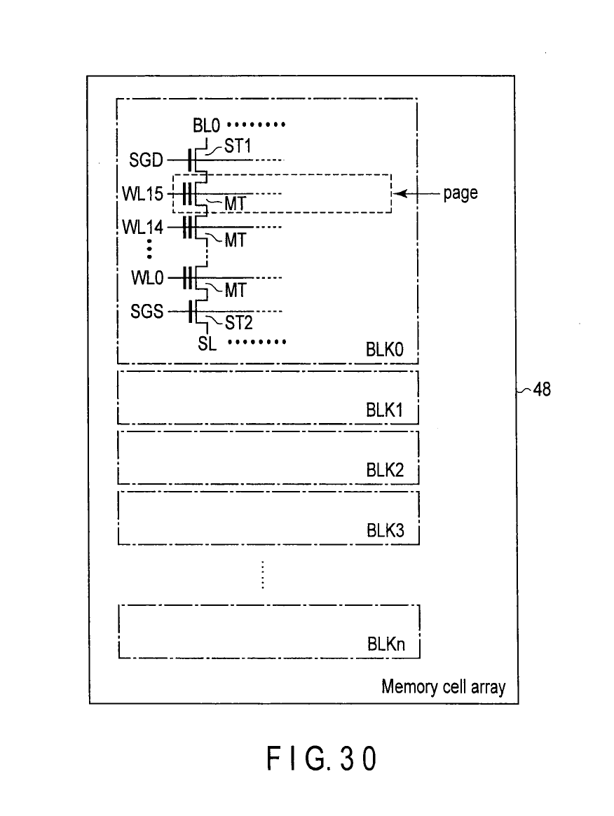

FIG. 30 is a block diagram of the memory cell array 48 of the NAND flash memory 31. As shown, the memory cell array 48 includes a plurality of blocks (physical blocks) BLK. Each of the blocks includes a plurality of memory cells MC connected in series between two transistors ST1 and ST2. The memory cells MC of the same row are connected to the same word line WL, and the memory cells MC connected to the same word line WL forms a page. Data is written by the page unit, and written in order from the memory cells MC closer to a source line SL. Data is erased by the block BLK unit. That is, the data in the block BLK are collectively erased. Physical addresses are allocated to the blocks (and pages). One AU is formed by one or more physical blocks.

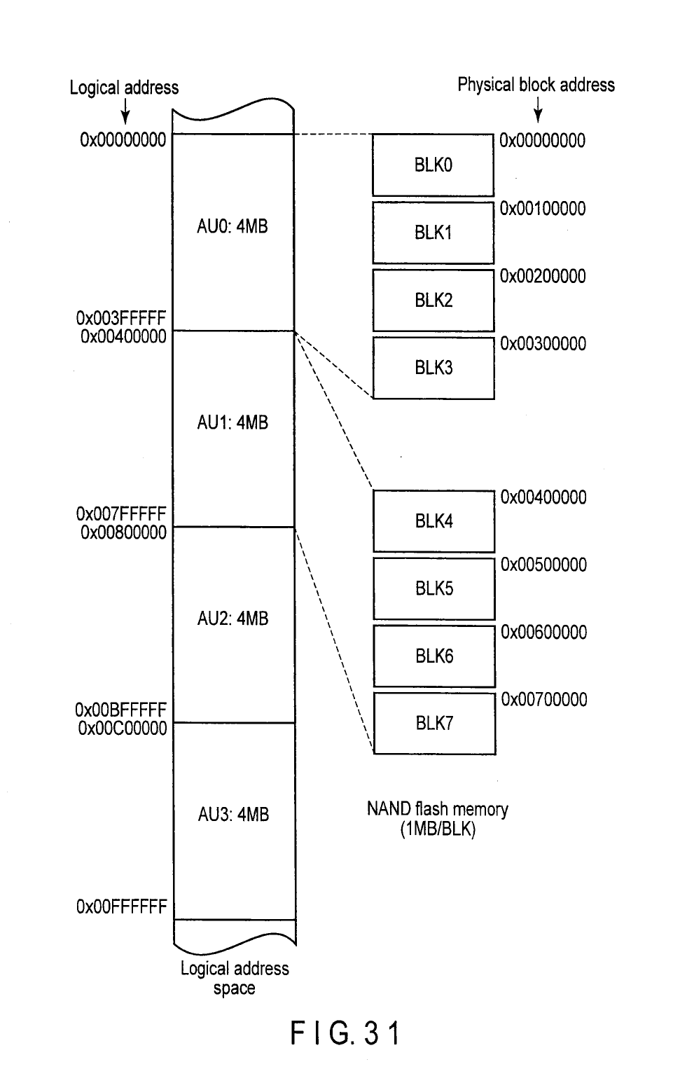

FIG. 31 is a schematic diagram showing the memory spaces (logical address spaces) when the memory card 2 is seen from the host apparatus 1, and the corresponding physical blocks BLK. As shown, the dedicated file system of the host apparatus 1 manages the logical address spaces by an AU unit having, for example, a size of 4 M bytes. Each of the AUs is associated with, for example, four blocks BLK. In the example shown in FIG. 31, the AU0 corresponds to the blocks BLK0 to BLK3, and the AU1 corresponds to the blocks BLK4 to BLK7. This correspondence changes with time due to, for example, the operation including data copying. Therefore, this correspondence is recorded in the above-mentioned logical address/physical address translation table. The size of the AU is four times the size of the block BLK, and the boundary of the AU corresponds to the boundary of the block BLK. In other words, the head address (logical address) of the AU corresponds to the head address (physical address) of any of the blocks BLK, and the last address (logical address) of this AU corresponds to the last address (physical address) of any of the blocks BLK. Although the values of the logical addresses correspond to the values of the physical addresses in the example shown in FIG. 31, it should be understood that the boundaries may differ as long as writing performance is satisfied.

Although the size of the AU is the integral multiple of the physical block size in the examples described according to the above embodiments, the size of the AU may be the same as (one time) the block size. The AU is not limited to the concept defined by the Speed Class, and has only to be a management unit of the logical address spaces by the host apparatus 1. Even normal writing can be increased in speed by the recognition of the AU boundary and by sequential writing.

As has been described in detail in the third embodiment, the dedicated file system leaves unnecessary data in the cluster even when receiving a data deletion request or an overwrite request from the application 50. The dedicated file system then updates the FAT and thereby prohibits the use of the cluster. However, the dedicated file system may perform garbage collection to erase unnecessary data, when the remaining capacity of the memory card 2 is less than a given value or receiving a request from the application 50.

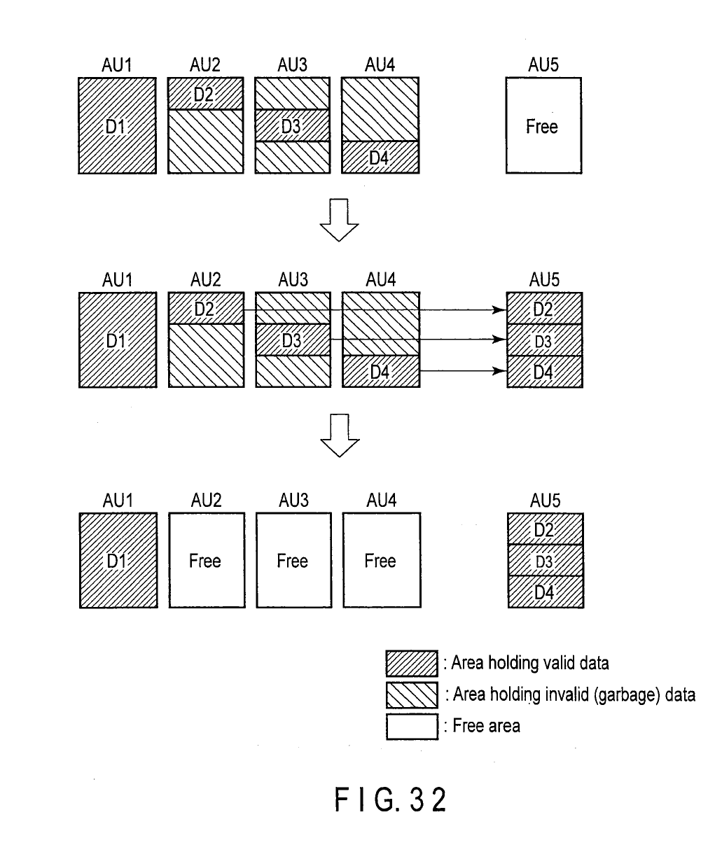

FIG. 32 is a conceptual diagram showing an example of garbage collection. As shown, data is held in a fragmented form in, for example, the AU1 to the AU4. In FIG. 32, an “area holding invalid (garbage) data” is an area holding the junk file described in the third embodiment or a file in which the FAT is set to an error code.

The dedicated file system then copies valid data D2 to D4 in the AU2 to AU4 to a free AU5. The dedicated file system then erases all the data in the AU2 to AU4. The dedicated file system also performs the processing of recording a data chain of new D2 to D4 in the FAT table of the AU5, and rewriting the FAT table of the AU2 to AU4 to free spaces.

As a result, the AU2 to AU4 are erased, and become areas in which data can be again sequentially written.

In the embodiments described above, the SD memory card is shown as an example of the memory device. However, the memory device is not exclusively the SD memory card, and may be any storage medium. The file system is not exclusively the FAT file system either.

Furthermore, the embodiments described above can be properly combined and carried out. For example, the host apparatus described in the above embodiments has a package of both the Speed Class writing that uses the CMD20 and the management by the AU unit. However, when the card does not support the CMD20, the host has only to omit the CMD20 and perform similar processing in the respective embodiments. Even the host apparatus which performs writing without using the CMD20 can have the advantage of inhibiting the data copying operation by the management based on the AU unit.

The embodiments described above include the following aspects.

[1] A Host Apparatus which Accesses a Memory Device, the Host Apparatus Including:

application software (the application 50 in FIG. 2) which issues, to a file system, a request for access to the memory device by an application interface (API);

a dedicated file system (the unit 51 and the file system 52 in FIG. 2) which manages a memory area of the memory device in accordance with a method appropriated to a flash memory in response to the access request; and

an interface circuit (the I/F 59 in FIG. 2) which enables communication between the dedicated file system of the host apparatus and the memory device,

wherein the dedicated file system manages logical address spaces of the memory device by predetermined unit areas (AUs in FIG. 6), and sequentially writes data into one of the reserved unit areas, and the sequential writing into the unit areas is executed by one or more write commands (CMD24 or 25), and

the application software issues the access request to the dedicated file system without recognizing a size of the unit area.

[2] DIR Entry Management, Unit-Area-Based Free Area Management, and Deletion Data Management

The host apparatus according to [1], wherein in response to a directory creation request from the application, the dedicated file system reserves a free unit area for a directory entry when a unit area for the directory entry is not reserved, and when a plurality of directories are created, the dedicated file system creates the respective directory entries in a free area of the reserved unit area,

when deleting data in the memory device, the dedicated file system manages the data by a method which does not allow a reuse of the data to be deleted (step S20 in FIG. 17), and

the dedicated file system calculates an entire size of a free area of the memory device in accordance with the number of the entirely unused unit areas and a partly-used unit area including a sequentially writable area.

[3] Selection of the Algorithm

The host apparatus according to [1], wherein when writing a file into the memory device, the dedicated file system manages the memory device in accordance with the size of file data information from the application software,

in the case of a file having small data or expected to be overwritten, the dedicated file system manages the memory device by using an algorithm (the fragmented AU write algorithm in FIG. 6) which gives priority to an area usage rate of the memory device,

in the case of a file having large data or unexpected to be overwritten, the dedicated file system manages the memory device by using an algorithm (the free AU write algorithm in FIG. 6) which manages data write areas for each of the unit areas and writes data sequentially in the unit, and

when the file data size is not determined yet, the dedicated file system recognizes whether a file attribute indicates that the file is likely to have large data by the file entry information in the directory entry (step S112 in FIG. 29), and selects the algorithm.

[4] Method of Judging Video Data

The host apparatus according to [3], wherein the dedicated file system recognizes whether the write data is a video file in accordance with file extension information recorded in the file entry within the directory entry or in accordance with an information field indicating whether the write data is a video file.

[5] Setting a Junk File to a Hidden File

The host apparatus according to [1], wherein the dedicated file system manages as a junk file in which a hidden file attribute is set as a way of preventing the reuse of data to be deleted.

[6] Cannot be Connected to the Junk File by the Data Deletion Method

The host apparatus according to [1], wherein the dedicated file system includes a FAT file system,

a memory space of the memory device is a set of clusters formatted by the FAT file system, and

when deleting data in the memory device by a cluster unit, the dedicated file system rewrites the FAT of a cluster holding data to be deleted to an error code or a final sector code as a way of preventing the reuse of data to be deleted (step S14 in FIG. 15).

[7] Cannot be Connected to the Junk File by the Data Overwriting Method

The host apparatus according to [1], wherein the dedicated file system includes a FAT file system,

a memory space of the memory device is a set of clusters formatted by the FAT file system, and

when overwriting at least some of data items in the memory device by a cluster unit, the dedicated file system sequentially writes overwrite data into the reserved unit area, and updates a link of the FAT (step S32 in FIG. 19), and

the dedicated file system rewrites the FAT of a cluster holding data to be overwritten to an error code or a final sector code as a way of preventing the reuse of the data to be overwritten.

[8] Connect to the Junk File by the Data Overwriting Method

The host apparatus according to [1], wherein the dedicated file system includes a FAT file system,

a memory space of the memory device is a set of clusters formatted by the FAT file system,

when overwriting at least some of data items in the memory device by the cluster unit, the dedicated file system sequentially writes overwrite data into the reserved unit area, and updates a link of the FAT (step S32 in FIG. 19), and

the dedicated file system leaves data to be overwritten as a junk file without erasing the data to be overwritten from a corresponding cluster as a way of preventing the reuse of data to be deleted (step S40 in FIG. 21).

[9] Simultaneous Single Stream Writing of a Plurality of Files

The host apparatus according to [1], wherein when simultaneously creating a plurality of files in response to a request by the application software, the dedicated file system reserves a unit area, and sequentially writes therein data in which the files are mixed (FIGS. 27 and 28).

[10] The Card Voluntarily Initializes the DIR Entry

The memory device accessed by the host apparatus according to [1], wherein when a command to reserve a directory entry area is received from the host apparatus, the directory entry area is initialized so that a specified area is filled with “0”, and the host apparatus does not need to initialize the directory entry area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A host apparatus capable of accessing a memory device, the host apparatus comprising:
application software which issues, to a file system, a request for access to the memory device by an application interface (API);
a dedicated file system which manages a memory area of the memory device in accordance with a method appropriate to a flash memory in response to the access request; and
an interface circuit which enables communication between the dedicated file system and the memory device,
wherein the dedicated file system manages logical address spaces of the memory device by predetermined unit areas, and sequentially writes data into one of reserved unit areas, and the sequential writing into the unit areas is executed by one or more write commands, and
the application software issues the access request to the dedicated file system without recognizing a size of the unit area.

2. The apparatus according to claim 1, wherein in response to a directory creation request from the application software, the dedicated file system reserves a free unit area for a directory entry when a unit area for the directory entry is not reserved, and when a plurality of directories are created, the dedicated file system creates the respective directory entries in a free area of the reserved unit area, and
when deleting data in the memory device, the dedicated file system manages the data by a method which does not allow a reuse of the data to be deleted.

3. The apparatus according to claim 1, wherein the dedicated file system calculates a sequentially writable size of the memory device in accordance with the number of the entirely unused unit areas and a partly-used unit area including a sequentially writable area.

4. The apparatus according to claim 1, wherein when writing a file into the memory device, the dedicated file system manages the memory device in accordance with file data information from the application software,
in the case of a file having small data or expected to be overwritten, the dedicated file system manages the memory device by using an algorithm which gives priority to an area usage rate of the memory device,
in the case of a file having large data or unexpected to be overwritten, the dedicated file system manages the memory device by using an algorithm which manages data write areas for each of the unit areas and writes data sequentially in the unit, and
when the file data size is not determined yet, the dedicated file system recognizes whether a file attribute indicates that the file is likely to have large data by the file entry information in the directory entry, and selects the algorithm.

5. The apparatus according to claim 4, wherein the dedicated file system recognizes whether the write data is a video file in accordance with file extension information recorded in the file entry within the directory entry or in accordance with an information field indicating whether the write data is a video file.

6. The apparatus according to claim 1, wherein the dedicated file system manages as a junk file in which a hidden file attribute is set as a way of preventing the reuse of data to be deleted.

7. The apparatus according to claim 1, wherein the dedicated file system includes a FAT file system,
a memory space of the memory device is a set of clusters formatted by the FAT file system, and
when deleting data in the memory device by a cluster unit, the dedicated file system rewrites the FAT of a cluster holding data to be deleted to an error code or a final sector code as a way of preventing the reuse of the data to be deleted.

8. The apparatus according to claim 1, wherein the dedicated file system includes a FAT file system,
a memory space of the memory device is a set of clusters formatted by the FAT file system,
when overwriting at least some of data items in the memory device by a cluster unit, the dedicated file system sequentially writes overwrite data into the reserved unit area, and updates a link of the FAT, and
the dedicated file system rewrites the FAT of a cluster holding data to be overwritten to an error code or a final sector code as a way of preventing the reuse of the data to be overwritten.

9. The apparatus according to claim 1, wherein the dedicated file system includes a FAT file system,
a memory space of the memory device is a set of clusters formatted by the FAT file system,
when overwriting at least some of data items in the memory device by the cluster unit, the dedicated file system sequentially writes overwrite data into the reserved unit area, and updates a link of the FAT, and
the dedicated file system leaves data to be overwritten as a junk file without erasing the data to be overwritten from a corresponding cluster as a way of preventing the reuse of data to be deleted.

10. The apparatus according to claim 1, wherein when simultaneously creating a plurality of files in response to a request by the application software, the dedicated file system reserves a unit area, and sequentially writes therein data in which the files are mixed.

11. The memory device accessed by the host apparatus recited in claim 1, wherein when a command to reserve a directory entry area is received from the host apparatus, the directory entry area is initialized so that a specified area is filled with “0”, and the host apparatus does not need to initialize the directory entry area.

12. A method of accessing a memory device in which a logical address space is managed by a dedicated file system in accordance with a predetermined unit area, the method comprising:
reading, by the dedicated file system, a size of the unit area from the memory device;
issuing, by application software, a request to access the memory device without recognizing the size of the unit area; and
reserving, by the dedicated file system, a unit area in the memory device and sequentially writing data in the reserved unit area in response to the request.

13. The method according to claim 12, wherein issuing the request includes:
issuing a directory entry creation request;
issuing a file open request;
issuing a data write request; and
issuing a file close request.

14. The method according to claim 13, further comprising:
reserving, by the dedicated file system, a unit area for a directory entry in response to the directory entry creation request;
creating, by the file system, a directory entry and a file entry in the reserved unit area in response to the file open request; and
updating, by the file system, a FAT and the file entry in response to the file close request,
wherein the sequentially writing data is executed in response to the data write request.

15. The method according to claim 12, wherein a memory space of the memory device is a set of clusters formatted by a FAT file system,
the method further including:
issuing, by the application software, a request to delete data in the memory device; and
rewriting, by the dedicated file system, the FAT of a cluster holding data to be deleted to an error code or a final sector code.

16. The method according to claim 12, wherein a memory space of the memory device is a set of clusters formatted by a FAT file system,
the method further including:
issuing, by the application software, a request to overwrite data in the memory device; and
sequentially writing, by the dedicated file system, data into a unit area, updating, by the dedicated file system, a link of the FAT, and rewriting, by the dedicated file system, the FAT of a cluster holding overwrite data to an error code or a final sector code.

17. The method according to claim 12, wherein a memory space of the memory device is a set of clusters formatted by a FAT file system,
the method further including:
issuing, by the application software, a request to overwrite data in the memory device; and
sequentially writing, by the dedicated file system, overwrite data into the unit area, updating, by the dedicated file system, a link of the FAT, and leaving data to be overwritten as a junk file without erasing the data to be overwritten from a corresponding cluster.
